(19) United States
(12) Patent Application Publication
(10) Pub. No.: US 2006/0045809 A1
(43) Pub. Date: Mar. 2, 2006

(54) Detection system for biological substances

(75) Inventors: Masataka Shirai, Higashimurayama (JP); Toshiki Sugawara, Kodaira (JP); Hiroyuki Uchiyama, Musashimurayama (JP); Chihiro Uematsu, Kawasaki (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd

(21) Appl. No.: 10/998,918

(22) Filed: Nov. 30, 2004

(30) Foreign Application Priority Data
Aug. 31, 2004 (JP) 2004-251516

(51) Int. Cl. G01N 21/00

(52) U.S. Cl. 422/82.11

(57) ABSTRACT

A biological sensor utilizing no label, such as a fluorescent material, and that does not require the setting of any marker to a sample. The sensor can make measurement easily and quickly. Molecules to be coupled with an object substance contained in a sample are oscillated, and state changes of the oscillating molecules are measured before and after the coupling, thereby measuring the weight of the object molecules. As a result, the influence of impurities that differ among oscillation states may be suppressed. Periodical signals caused by the oscillation of molecules are subjected to lock-in measurement to reduce the 1/f noise generated by the combination of the object substance with the receptor on the surface of a solid body to improve measurement sensitivity.

### CLAIM OF PRIORITY

The present application claims the benefit under 35 U.S.C. § 119 of the earlier filing date of Japanese Patent Application JP 2004-251516 which was filed on Aug. 31, 2004, the content of which is hereby incorporated by reference into the present application.

### BACKGROUND OF THE INVENTION

1. Field of the Invention

The present invention relates to a system for detecting and assaying biological substances, viruses, and bacteria in research institutes, pharmaceutical companies, and hospitals, and, more particularly, the present invention relates to a system and method for assaying and inspecting antibodies and genes in clinical examinations and for detecting detrimental chemical substances and bacteria existing in the environment.

2. Description of the Background

Conventionally, there have been many well-known methods for detecting biological substances in various technical fields. Among them, assay methods makes good use of biomolecules (e.g., antibodies, RNA and DNA) referred to as “receptors” that react on or are combined with object biological substances to be detected.

Particularly, the immunoassay method is widely employed in both the clinical assay and food inspection fields. This immunoassay method is divided into different categories according to the marker used in the assay and inspection. The categorized methods that are used frequently are, for example, the Immunofluorometric Assay that uses fluorescent markers, the Immunoradiometric Assay that uses radioactive elements as markers, and the Enzyme-linked Immunosorbent Assay that uses reactions of oxygen. Generally, these methods are highly sensitive and not very expensive. In addition, they are generally capable of carrying out many assays and inspections simultaneously.

However, the above methods that use markers have been confronted with the following problems. When using such a marker, it is always required to couple the marker with an object biological substance to be detected, either directly or indirectly. It therefore takes much labor and time to carry out the marker reaction process. Additionally, a reagent used for those assays and inspections is required to correspond to various biological substances. It therefore takes much time and much cost to develop a marker, and the cost of the reagent rises. In addition, in many cases, the quantity of each object biological substance is required to be measured continuously when the substance is to be applied to a plant. In that connection, because markers are supplied continuously, both the cost and maintenance frequency increases quickly. Finally, in research/development processes, the biological substances with which the markers are coupled are required to be collected. When they are to be reused, it is often difficult to separate the markers from those biological substances.

On the other hand, methods that utilize no such marker (“unlabeled assay methods”) are generally lower in both sensitivity and the accuracy of measurement when compared to assay methods that use markers. In many cases, labeled assay methods have been employed to avoid these two problems. However, it is an object of the present invention to solve these two problems while utilizing unlabeled assay methods.

Hereunder, a description will be made for several conventional techniques of both unlabeled assay methods and detection systems for biological substances. An unlabeled assay method often uses a substrate and immobilizes a chemical substance (receptor) to be coupled selectively with an object biological substance to be detected on the substrate. The method then detects the object substance using changes of the refractive index and/or the charge distribution around a surface of the substrate. Those changes are caused by the coupling of the object substance with the receptor. Actually, however, monoclonal antibodies are often produced as receptors so that each will be coupled selectively with an object substance in the medical, food, and other fields.

Since such a measurement method can measure changes of the weight of molecules over time in both an object substance and a receptor that are combined with each other, measurement can be taken continuously without requiring the addition of a reagent. Furthermore, while the method has been employed in many research institutes as described above, the method can also measure the constant of coupling/dissociation of each receptor with/from each object substance.

There is also a well-known detection system that uses an unlabeled assay method that makes use of such a receptor to detect changes of the refractive index and/or charge distribution around the surface of the substrate. This method is generally classified into five types. The first type uses surface plasmon resonance and is the most widely used method (see, e.g., L. S. Jung et al.; Langmuir vol. 14, p. 5636 (1998), hereafter “Non-Patent Document 1”). The second type detects the phase changes of a light transmitted through an optical waveguide (see, e.g., R. E. Dessy; Analytical Chemistry vol. 57, p. 1188A (1985), hereafter “Non-Patent Document 2”). The third type detects the intensity changes of a light transmitted through an optical waveguide. The fourth type uses changes of a multiple reflected light spectrum in a thin film. The fifth type is an electrical one that uses the changes of a current flowing on the surface of a semiconductor.

Among these unlabeled assay methods, the method that uses the phase changes of a light is the highest in sensitivity. Particularly, a method that uses a Mach-Zehnder Interferometer is the simplest configuration to realize the light phase detection (see, e.g., Non-Patent Document 2; U.S. Pat. No. 6,137,576, herafter “Patent Document 2”; and U.S. Pat. No. 6,429,023, hereafter “Patent Document 3”). Hereunder, a description will be made for the principles of an assay method that uses a Mach-Zehnder Interferometer.

FIGS. 2 and 3 show basic configurations of a detection system for biological substances which uses a Mach-Zehnder Interferometer. FIG. 2 shows a top view of a sensor chip 200 (substrate for composing a sensor) and a block diagram of its peripheral devices. FIG. 3 shows a cross sectional view of the sensor chip 200 through line A-A. A laser beam emitted from a laser beam source 16 that oscillates in a single mode (wavelength) is guided into an optical waveguide 501 formed on the substrate 200 through optical fiber 106 or a similar medium. This beam guidance uses light coupling means 701 such as lenses and fiber connectors. The laser beam transmitted through the optical waveguide 501 is converged into two optical waveguides 516 and 517.

The laser beam transmitted through one optical waveguide 516 passes a region 400 in which a receptor 100 is immobilized (FIG. 3). The receptor 100 is to be combined selectively with an object substance 101 to be detected. The laser beam transmitted through the other optical waveguide 517 goes to a region 401 in which no substance 101 is combined. In other words, only the laser beam transmitted through the optical waveguide 516 and the object substance interacts with each other. Those laser beams are combined/interfere with each other again, and re then transmitted in the optical waveguide 502. Because of this mutual interference, a light intensity change occurs corresponding to the phase difference between the laser beams transmitted through the optical waveguides 516 and 517. The laser beam with the changed intensity is converted to a current signal by a photo detector 40 through an optical coupling means 702 and an optical transmitting means 107 such as an optical fiber.

In the above configuration, the object substance 101 is combined with the receptor 100 in the region 400. However, the laser beam transmitted through the optical waveguide 516 oozes out around the substrate, so that beam phase changes occur in accordance with the degree to which the substances are combined with the receptors.

As shown in FIG. 4, because the beam phase change is related to the light intensity sinusoidally, the relationship between the amount of combined object substances 101 and the light intensity detected by the photo detector 40 also becomes sinusoidal. This relationship is used to enable a correspondence between the amount of combined substances and the output of the photo detector. The horizontal axis in FIG. 4 denotes a phase difference between the laser beams transmitted through the optical waveguides 516 and 517. The vertical axis denotes the light intensity output from the optical waveguide 502 shown in FIG. 2. In order to convert a phase change denoted by the horizontal axis to an amount of combined object substances, the relationship between a phase change measured by another method (previously used) and an amount of the combined substances is used.

Next, a description will be made of the change in light phase caused by coupling the of an object substance with a receptor. FIG. 3 shows a cross sectional view of a configuration for measurement at the A-A line in FIG. 2. The laser beams transmitted through the optical waveguides 516 and 517 leak slightly therefrom into regions (400 and 401) in which there is some solution or gas that contains object substance 101. Consequently, when the object substance 101 is coupled with the receptor 101, the refractive index rises around the surface in accordance with the amount of coupling between the substances, whereby the refractive index of the laser beam transmitted through the optical waveguide 516 changes. The phase change of the laser beam passing the region 400 becomes larger than the phase change of the laser beam passing the region 400. In other words, the phase difference between those two laser beams increases in proportion to the amount of combined (coupled) substances.

Next, a description will be made of a conventional technique for detecting biological substances which uses absorption coefficient changes of an optical waveguide (see, e.g., International Patent Publication No. WO92/05429, hereafter “Patent Document 4”). FIG. 5 shows a top view and FIG. 6 shows a cross sectional view of the detection system, respectively. The configuration and operation principles of the detection system are as follows. As in the above case, a laser beam emitted from a laser beam source 16 is guided into an optical waveguide 501 provided on a substrate 200. The laser beam guided into the waveguide 501 is then converged into two waveguides 518 and 519. At that time, the laser beam passing one optical waveguide 518 passes a region 400 in which a receptor 100 to be coupled selectively with an object substance is immobilized while the laser beam passing the other waveguide 519 goes to a region 401 in which no substance is combined with the receptor 100.

In the region 400 where a receptor 100 is immobilized, the absorption coefficient increases due to the combined object substance and the intensity of the light output from the optical waveguide 518 becomes weaker than that of the optical waveguide 519. In other words, the intensity difference between the lights output from the optical waveguides 518 and 519 is in proportion to the amount of the combined object substances 101. Photo detectors 40 and 41 convert light intensity to a current flow (through coupling means 702, 703 and transmission means 107, 108. The light absorption index changes due to the combined object substances because a light leak occurs, so that the light distributions 402 and 403 interact with the object substance as shown in FIG. 6.

A method using surface plasmons is also used to measure the refractive index changes that occur around the surface of a metal when an object substance to be detected 101 is combined with a receptor 100 (see, R. Karlsson, R. Stahleberg; Anal. Biochem. 228, p. 274 (1995), hereafter “Non-Patent Document 4”). FIG. 7 shows a configuration for the measurement. At first, a low reactive metallic thin film 521 made of, for example, gold (Au), is formed on a transparent substrate 520, and then a receptor 100 is immobilized thereon. The substrate 520 is provided on a prism 523 and a laser beam output from a laser beam source or LED light source 524 is injected into the prism 523 at a proper angle.

The laser beam from the source has proper angle distribution 527, and the laser beam reflected at almost all the injection angles is received by an image pickup device 525. However, the reflection light of the laser beam that goes into a direction denoted by a polygonal line 526 becomes weak. This is because the surface plasmon is excited very efficiently on the surface of the metallic thin film 521. This light intensity angle dependency is measured by the image pickup element 525. It is well known that the specific angle 528 is determined by an optical constant of the metallic thin film 521 and the refractive index around the surface thereof. This refractive index changes due to the combined object substance 101, so that the light intensity distribution can be measured by the image pickup element to measure how much the object substances 101 are combined with the receptor 100.

There is also another method for measuring the above excitation angle and still another method for measuring a reflected light spectrum known as the unlabeled assay methods (see, Non-Patent Document 1). Particularly, there is a method for depositing a metallic thin film on an optical waveguide and/or optical fiber to excite the surface plasmon, thereby measuring the spectrum of an object transmission light (see, R. C. Jorgenson, S. S. Yee; Sens. Actuators B12, p. 213, (1993), hereafter “Non-Patent Document 5”).

Next, a description will be made for an assay method that uses the changes of a current flowing on a surface of an object semiconductor. FIG. 8A and FIG. 8B show configurations for the method. Regions 111 and 112 provided on a semiconductor substrate 110 are used as a source region and a drain region. A channel layer 113 is formed in each of the source region 111 and the drain region 112, and a sheeted current flows in each of the regions 111 and 112. Thereafter, a gate insulator 115 and a gate electrode 114 are formed on the channel, and a receptor 100 is immobilized on the gate electrode 114.

If it is assumed that an object substance to be detected 101 is charged, the charge amount on the surface of the gate electrode 114 changes due to the degree to which the substance 101 is combined (coupled) with the receptor 100. This change causes a change in the state density of the channel layer 113 whereby the current between the source and the drain also changes. In other words, the source-drain current change enables measurement of the degree to which the substance 101 is combined with the receptor 100. The receptor 100 and an electrode may be combined so that an ion-selective gate electrode that makes an object substance (ion) 101 combine with a receptor selectively instead of the gate electrode 114 (see, IEEE Trans. Biomed. Vol. 17, p. 70, (1970), hereafter “Non-Patent Document 6”). Moreover, there is a known example that uses a polysilicon thin line as a channel layer (see, Japanese Patent Application No. JP-A No. 278281/1996, hereafter “Patent Document 5”).

Next, a description will be made of an assay method for using multiple reflection light spectrum changes in a thin film. As in the above-described methods, this method uses refractive index changes caused by a combined (coupled) object substance 101. FIG. 9 shows a block diagram of such an assay device. The system immobilizes a receptor 100 on a thin film 530 and measures the degree to which the substance 101 is combined with the receptor 100. A light 533 output from a white light source 532 is injected in the thin film from its rear side at a proper angle through a prism 531. A polygonal line 533 in FIG. 9 denotes the light path. When an object substance 101 is combined with the receptor 100, the refractive index around the thin film 530 changes, so that the multiple reflection condition in the thin film 530 changes, whereby the reflection spectrum changes. The system measures this change with use of a spectroscope 535 and an image pickup device 536. An optical detector is typically used as the image pickup device, thereby the light spectra come to be measured at a time.

Two other related documents include: U.S. Pat. No. 5,465,151 (“Patent Document 1”); and L. M. Lechuge, A. T. M. Lenferink, R. P. H. Kooyman, J. Greve; Sensors and Actuators B, 24/25, p. 762 (1995) (Non-Patent Document 3”).

The above unlabeled assay methods have been confronted with common problems: insufficient sensitivity and accuracy in measurement. The insufficient measurement sensitivity is often caused because the minimum amount of a substance is large and the insufficient measurement accuracy is often caused because many errors occur in measured values due to the sample refining condition. When such sensitivity and accuracy of measurement are compared with those in the case in which a fluorescent marker is used, the result will become as follows. In proportion to an amount of an object substance to be detected, the fluorescent substance is combined more/less with the substrate. Therefore, a stronger excitation light source and a higher sensitive photo-detector should be used to favorably measure the fluorescent substance on the substrate. The sensitivity can also be improved by modulating the intensity of the excitation light source to reduce the influence of noise lights other than fluorescent components that are signals, and then subjecting the modulated intensity to lock-in measurement. On the other hand, the unlabeled assay method measures an amount of a combined object substance by converting the amount to a change of the phase, intensity, or spectrum of the light passing the substrate.

At that time, impurities or similar materials that combine with the receptor at random on the substrate (or waveguide) come to cause a change in the phase, intensity, and spectrum of the light. This then becomes a factor for lowering the sensitivity and accuracy of measurement. At the same time, if the substrate temperature changes, it causes a change in the light transmission characteristic, thereby both sensitivity and accuracy are lowered. Both noise and error factors caused by such impurities cannot be eliminated even by lock-in detection carried out by modulating the light injected into the substrate. On the other hand, there are many cases in which each substance is detected in extremely small quantities in medical and food assays and inspections. At that concentration, the impurity density is usually used under far more severe conditions than those for the object substance density. This causes the noise/errors introduced by impurities to become very serious problems. Under such circumstances, it is an object of the present invention to reduce such noise and errors to improve both the sensitivity and the accuracy of measurement.

### SUMMARY OF THE INVENTION

According to one aspect of the present invention, a detection system for biological substances, which detects an object substance contained in a solution being in contact with an optical waveguide formed on a substrate, comprises: light injecting means for injecting a light into the optical waveguide; light detecting means for detecting a light output from the optical waveguide; a receptor to be coupled selectively with the object substance to be detected; oscillation excitation means for applying oscillation to the receptor so as to change a distance between the receptor and a surface of the optical waveguide; and a signal processing part for calculating any of the amplitude, frequency, and/or phase of the oscillation of the receptor excited by the oscillation excitation means according to a signal output from the light detection means.

According to another aspect of the present invention, the detection system for biological substances described above is modified slightly so that the receptor is enabled to increase the oscillation by adding a microparticle coupled with the receptor which is sensitive to an electrical field generated by the oscillation excitation means and a tether molecule for tethering the receptor to a portion around the surface of the optical waveguide. The tether and microparticle are used to impart increased oscillations to the receptor.

According to still another aspect of the present invention, the detection system for biological substances, which detects an object substance contained in a solution being in contact with a thin film, comprises: a substrate having a dielectric material capable of passing a light and a thin film formed on a surface of the dielectric material; means for injecting light into the interface between the dielectric material and the thin film; and means for measuring an attribute (intensity, spectrum, or intensity distribution) of light reflected from the interface. The system further includes a receptor to be coupled selectively with the object substance, oscillation excitation means for exciting the oscillation of the receptor, and means for measuring any of the amplitude, frequency, and/or phase of the oscillation of the receptor according to a signal output from the detector for detecting the attribute of the light.

According to still another aspect of the present invention, the detection system for biological substances comprises: an optical waveguide provided on a substrate; a metallic thin film formed at a side surface of the optical waveguide; means for exciting surface plasmons by guiding a light into the optical waveguide; means for measuring an attribute (intensity, spectrum, and/or intensity distribution) of a light passing through or reflected from the optical waveguide; means for detecting an object substance contained in a solution being in contact with the metallic thin film; a receptor to be coupled selectively with the object substance; oscillation excitation means for exciting the oscillation of the receptor; and means for measuring any of the amplitude, frequency, and/or phase of the oscillation of the receptor.

The present invention is intended to improve both the sensitivity and accuracy of measurement by enabling a receptor to oscillate and using both of the oscillation signal and a detected signal to carry out lock-in measurement in an unlabeled assay biological sensor (unlabeled biological substance assay device).

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 is a basic block diagram of an unlabeled biological sensor according to the present invention;

FIG. 2 is a block diagram of a conventional unlabeled biological substance assay device that uses a Mach-Zehnder Interferometer;

FIG. 3 is a cross sectional view of the conventional unlabeled biological substance assay device through line A-A in FIG. 2;

FIG. 4 is a graph denoting the operation point of a conventional unlabeled biological assay device that uses a Mach-Zehnder Interferometer;

FIG. 5 is another block diagram of a conventional unlabeled biological assay device that uses the light absorption of an optical waveguide;

FIG. 6 is a cross sectional view of the conventional unlabeled biological assay device through line A-A in FIG. 5;

FIG. 7 is another block diagram of a conventional unlabeled biological assay device that uses surface plasmon;

FIG. 8 depicts block diagrams of a conventional unlabeled biological assay device that use current changes on a substrate (FIG. 8A and FIG. 8B);

FIG. 9 is another configuration of a conventional unlabeled biological assay device that uses multiple reflection of light from a dielectric thin film;

FIG. 10 is a chart describing the contribution of the noise of both the conventional unlabeled biological assay device and that of the present invention;

FIG. 11 is a graph describing the contribution of errors caused by impurities according to a conventional technique;

FIG. 12 is a graph for describing the contribution of errors caused by impurities according to the present invention;

FIG. 13 is a block diagram corresponding to a first embodiment;

FIG. 14 is a cross sectional view through line A-A in FIG. 13;

FIG. 15 is a cross sectional view through line B-B in FIG. 13;

FIG. 16 a graph denoting operation points in the first embodiment;

FIG. 17 is a graph describing a method for reducing errors caused by impurities in the first embodiment;

FIG. 18 is a block diagram corresponding to a second embodiment;

FIG. 19 is a block diagram corresponding to a third embodiment;

FIG. 20 depicts five graphs for describing the operation of the third embodiment (FIGS. 20A through 20E);

FIG. 21 is a block diagram corresponding to a fourth embodiment;

FIG. 22 is a block diagram corresponding to a fifth embodiment;

FIG. 23 is a block diagram corresponding to a seventh embodiment;

FIG. 24 is a diagram of immobilized molecules corresponding to those in the sixth embodiment;

FIG. 25 is a block diagram corresponding to an eighth embodiment;

FIG. 26 is another block diagram corresponding to the fifth embodiment;

FIG. 27 is a block diagram corresponding to a ninth embodiment;

FIG. 28 is a block diagram corresponding to a tenth embodiment;

FIG. 29 is a chart for describing how to excite surface plasmons in the tenth embodiment;

FIG. 30 is a block diagram corresponding to an eleventh embodiment;

FIG. 31 is a cross sectional view corresponding to the eleventh embodiment;

FIG. 32 is a block diagram corresponding to a twelfth embodiment;

FIG. 33 is a top view corresponding to a thirteenth embodiment;

FIG. 34 is a block diagram corresponding to the thirteenth embodiment;

FIG. 35 is a cross sectional view corresponding to a fourteenth embodiment;

FIG. 36 is a block diagram of a signal processing system of the present invention; and

FIG. 37 is another basic block diagram of the detection system for biological substances of the present invention, which uses tether molecules and microparticles to improve the measurement sensitivity.

### DETAILED DESCRIPTION OF THE INVENTION

Initially, the factors for lowering both sensitivity and accuracy of measurement are described. These factors are problems with the conventional unlabeled biological substance assay devices (hereinafter, to be referred to as “unlabeled biological sensors”) described in the background of the invention. Thereafter, methods to suppress these factors with the configurations disclosed according to the present invention will be described.

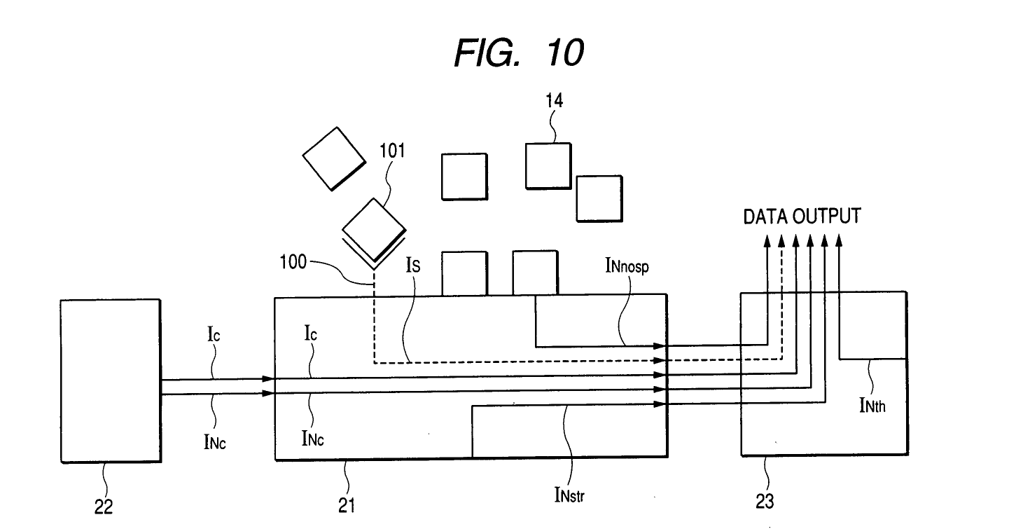

The factors will be classified as follows. Hereinafter, those factors for lowering both sensitivity and accuracy of measurement are referred to as “fluctuation” generically. The factors for lowering the measurement sensitivity are referred to as “noise” while the factors for lowering the measurement accuracy are referred to as “errors.” FIG. 10 shows a general explanatory view of such an unlabeled biological sensor. Each solid line arrow denotes a path in which a fluctuation factor is superimposed on signals.

The principles of a general biological sensor will first be described. A receptor 100 is immobilized on a substrate 21 to detect an object biological substance 101 to be combined with the receptor 100. A flow of energy referred to as a carrier is generated in a region of the substrate 21 on which the receptor 100 is immobilized. The carrier is modulated by the substance 101 combined with the receptor 100. For example, if a light intensity change is to be measured, the carrier is a light, so that an optical waveguide is formed on the substrate so as to flow the carrier therein. Carrier modulation means changing of the intensity, amplitude, phase, and/or frequency of light or similar energy. The carrier output from a carrier generator 22 is modulated in accordance with the degree to which the substance 101 is combined or coupled with the receptor 100 when the carrier passes through the substrate.

After that, the carrier is converted to an electrical signal by a detector 23. The signal is processed after it is converted to the electrical signal and is then output as a combined substance amount signal. The carrier intensity is assumed as I_{C}, the carrier fluctuation I_{NC} that occurs when the carrier is generated is superimposed on I_{C} as a signal fluctuation factor. As a concrete example of the carrier fluctuation I_{NC}, there are laser diode relative intensity noise (RIN) and phase noise when an optical waveguide is used, as well as wavelength fluctuation when the surface plasmon method is used.

After that, when the carrier passes through the substrate 21 on which the receptor 100 is immobilized, the fluctuation I_{Nstr} is superimposed on I_{C}. As an example of I_{Nstr}, there is a case in which when a Mach Zehnder Interferometer is formed, the refractive index of the material used for the optical waveguide changes due to a temperature change, whereby the interference condition also changes and the output optical signal fluctuates and/or a light leaks when it is inputted to the optical waveguide provided on the substrate while the leak light and the output light come to interfere each other. The interference condition thus comes to change due to the temperature change, thereby causing the light intensity to fluctuate.

After this, the fluctuation I_{Nnosp} occurs under the influence of the impurities 14 contained in the sample other than the object substance 101 and is superimposed on an object together with the signal Iₛ when the object substance 101 is combined with the receptor 100. And, a signal obtained by synthesizing all of these is converted to an electrical signal by the detector, then subjected to a signal processing. Also at that time, the thermal noise I_{Nth} of the light receiving/amplifying/signal processing devices are superimposed one upon another. In other words, the signal noise (fluctuation) ratio (S/N) is determined by the four types of fluctuations as shown in Equation 1.
S/N=I_{S}/(I_{Nstr}+I_{Nc}+I_{Nnosp}+I_{Nth}) Equation (1)

In ordinary lock-in measurement, it is effective to modulate the I_{c} periodically to reduce the I_{Nc}. And, as shown in the Equations (2), the signal intensity Iₛ increases/decreases in proportion to the carrier intensity I_{c}.
Iₛ=cηθI_{c}
I_{Nnosp}=C′εηθI_{c} Equations (2)

The carrier intensity I_{c} can therefore be increased to improve the S/N. In the expression, the η denotes modulation efficiency of the carrier intensity by combination of an object substance (a ratio of carrier change to substance combination), the θ denotes the transmission index of the carrier intensity when passing through an object substrate, and the C denotes the density of an object substance to be detected.

As to be understood from Equations (2), the fluctuation I_{Nnosp} caused by impurities also increases/decreases in proportion to the carrier intensity, so that an increase of the I_{c} is not effective so much to improve the S/N. In this expression, the C′ denotes impurity density and the ε denotes impurity non-selective combination rate (a ratio of possibility to combine impurities with respect to combining of non-object substances). Furthermore, the impurity density is often higher by at least six orders of magnitude than the density of the object substance to be detected 101. The ε value is usually within 10³ to 10⁶. Therefore, the fluctuation I_{Nnosp} caused by impurities often becomes larger than that of the signal generated by the object substance 101. This has also been a conventional problem. Particularly, if a sample that contains the object substance is not refined enough beforehand, the above problem is required to be solved. Generally, this problem is also required to be solved for each method that detects chemical substances to be combined with a substrate.

As described above, there has been no method considered to be effective for reducing both of the fluctuation I_{Nstr} generated in a sensor chip and the fluctuation I_{Nnosp} caused by impurities in an unlabeled sensor. Hereinafter, methods for reducing those fluctuation factors will be described.

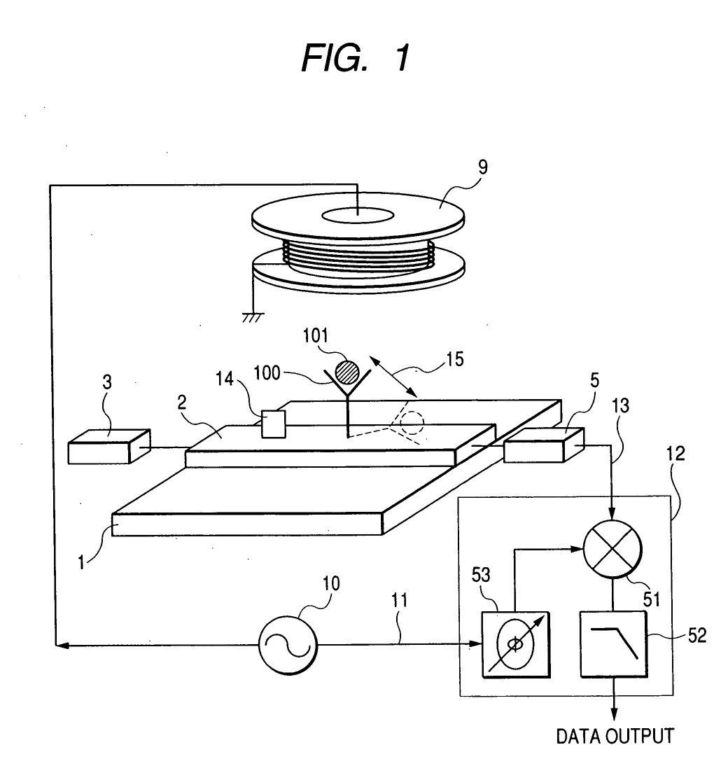

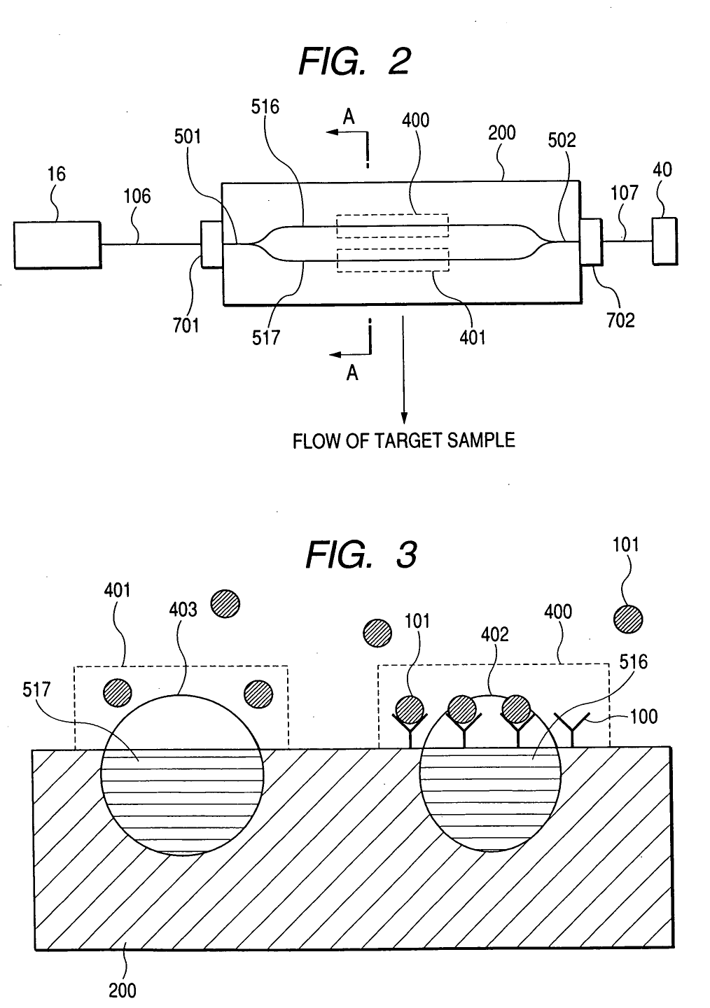

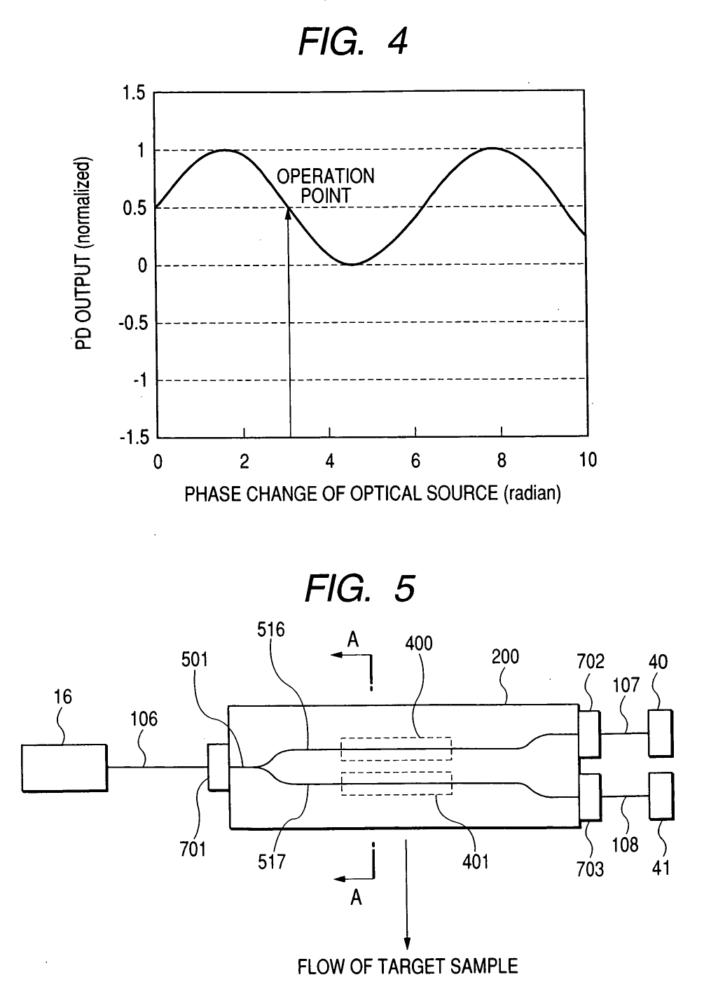

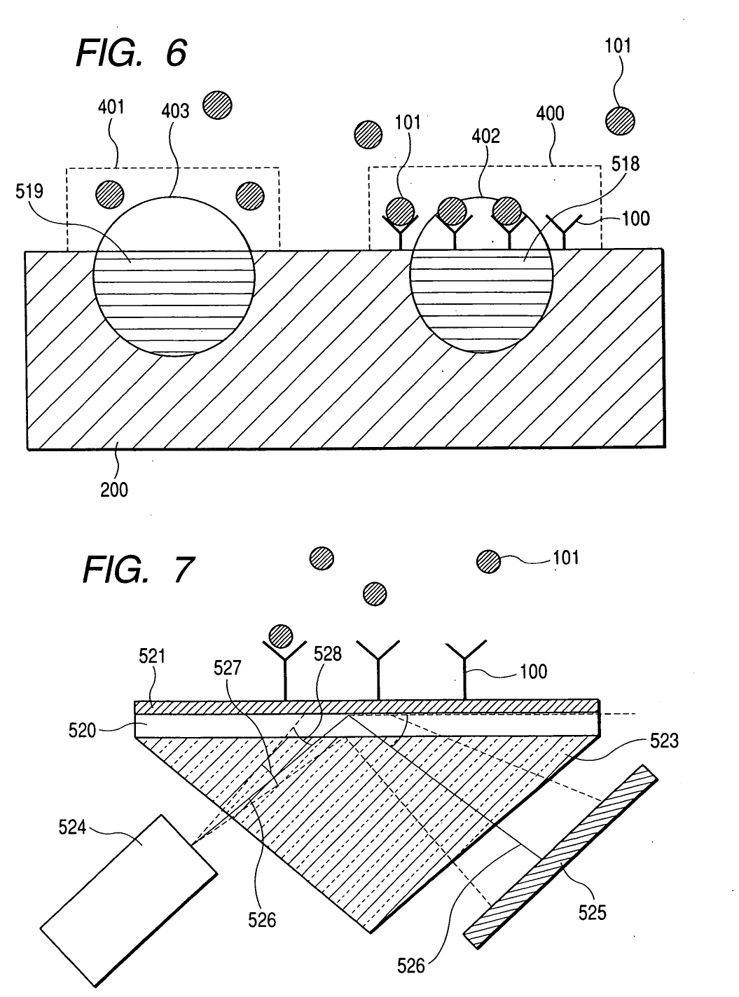

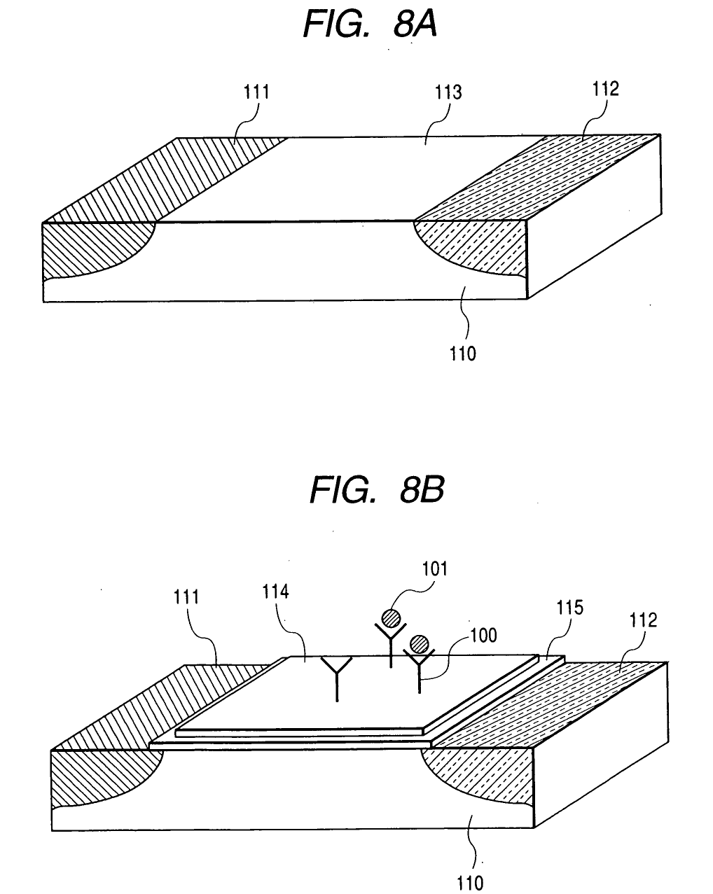

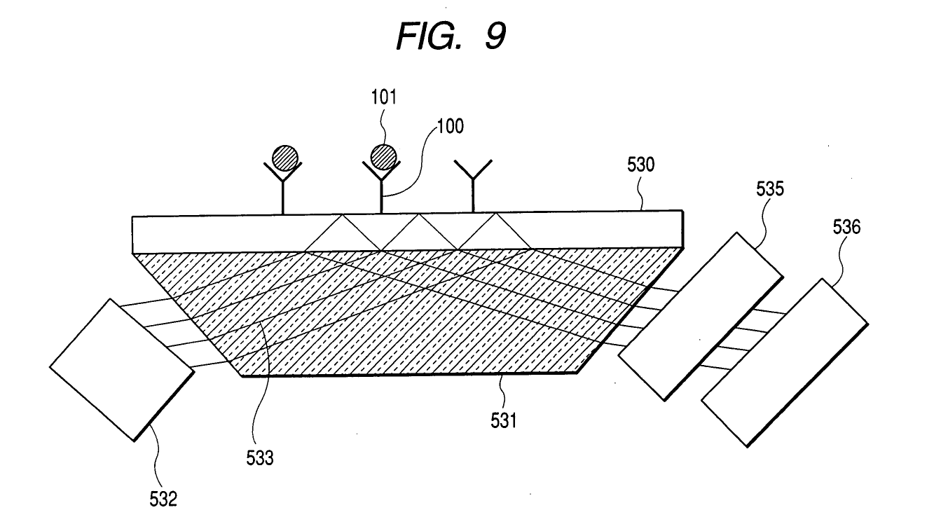

FIG. 1 shows a basic block diagram of an unlabeled biological sensor according to the present invention. This sensor configuration is abstracted so that it is applied to any of the conventional unlabeled biological sensors described in the background of the invention. The components of the sensor will be described with reference to concrete examples.

At first, a structure 2 is formed on a substrate 1 to pass a carrier therethrough. Concretely, the carrier may be a current. A device 3 for generating this carrier is a laser beam source, current source, or high-frequency source. The carrier is injected into the structure 2. The structure 2 enables part of the carrier to ooze into a solvent that contains an object substance to be detected 101. The structure 2 also changes the intensity, phase, and/or state of the carrier according to a distance to the object substance, as well as an amount of the substance. The carrier is then modulated by the object substance in the carrier detector 5, and is then measured.

In each conventional sensor configuration, a receptor is immobilized closely to the structure 2 to selectively collect the object substance to a portion around the structure 2. The sensor of the present invention is provided with means for moving or oscillating this receptor in a given cycle at a given distance or in a given orientation from the structure 2. In other words, this receptor is movable and immobilized at the structure 2 so that it is not separated from the carrier until it reaches a region in which the interaction between the receptor and the carrier is disabled. This receptor selects molecules capable of receiving a force of an oscillation field (electrical field, magnetic field, etc.) from an external source.

Specifically, the sensor of the present invention includes an oscillation field generator 9 for oscillating this receptor 100. This receptor may be an antibody and/or single stranded DNA (deoxyribonucleic acid). If any of these is selected, an immobilized receptor that satisfies the above two conditions naturally is obtained. In other words, molecules, when immobilized at the structure 2 through an amino group or the like, come to be enabled to make a rotating/oscillating movement. Since it includes such ions obtained in a proper solvent, the receptor can receive a force from an electrical field.

In this basic configuration of the sensor, the receptor alternates between a standing state (solid line of receptor 100) and non-standing state (dotted line of receptor 100) (shown as line 15 in FIG. 1) repetitively under the control of the oscillation field generator 9 as shown in FIG. 1. Consequently, the average distance between a composite of the receptor or sample and the receptor and the structure 2 (the optical waveguide) can be timely oscillated. In this configuration, although the receptor is movable and can receive a force, these two functions may be replaced with another optimal means.

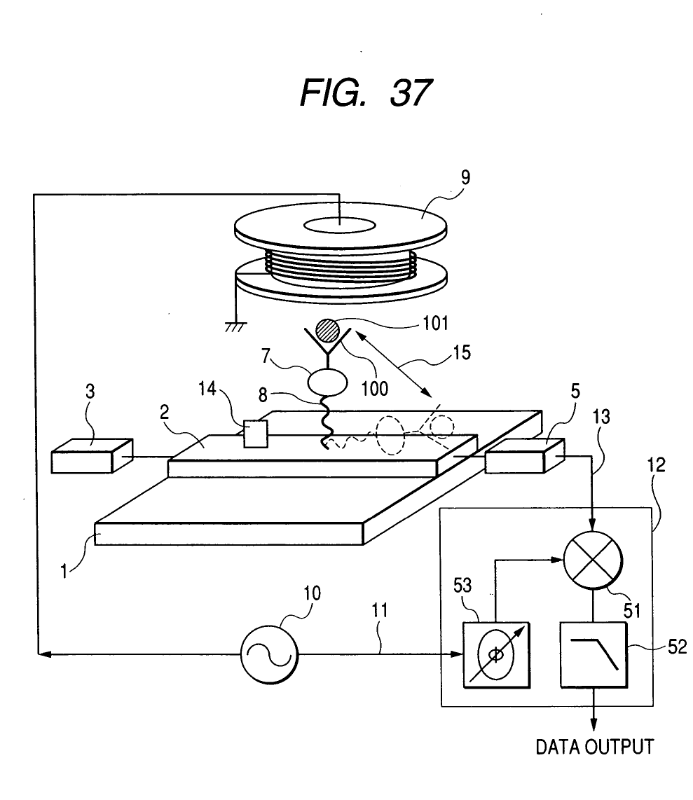

FIG. 37 shows a configuration that includes such optimal means. Initially, a receptor 100 is immobilized closely to a surface of the structure (the optical waveguide) and a tether molecule 8 (coupling molecule) is used to apply oscillation to the receptor. After that, in order to enable the receptor 100 to receive a force from an oscillation field efficiently, a microparticle 7 which is sensitive to the magnetic field generated by the oscillation field generator 9 is coupled with the receptor 100. Consequently, the receptor or the composite of the receiver and the sample comes to be oscillated at a large amplitude, whereby the detector sensitivity is improved. The oscillation field generator 9 receives signals from an oscillation field signal generator 10 to make the oscillation field act on the microparticle.

Next, a method for detecting an object substance in the above configuration will be described. In the above configuration, when the receptor is oscillated, the carrier passing through the structure 2 is modulated by the oscillation. This is why the receptor movement is measured. If the object substance 101 contained in the sample is combined with the receptor 100, the composite of the receptor and the object substance begins oscillating, Whereby the modulation state of the carrier is changed. For example, the oscillation of the composite may modulate the carrier more strongly. In other words, the carrier detector 5 comes to be modulated with a larger amplitude. This change of the modulation amplitude makes it possible to measure the amount of the combined (coupled) object substance.

Next, a mechanism for improving the measurement sensitivity will be described. The modulation signal corresponding to the above receptor oscillation is synchronized with the oscillation signal received from the oscillation signal generator to enable the signal processing part 12 to make lock-in detection, thereby improving the measurement sensitivity. In other words, this lock-in detection can reduce the noise components contained in the fluctuation factors I_{Nnosp} and I_{Nstr}. This occurs because the noise components are almost those of the I/f noise and the S/N ratio can be improved by raising the oscillation field frequency.

Components of the noise caused by impurities can be eliminated according to a result of measurement of the noise, carried out by applying an oscillation field to the noise with a frequency other than that with which impurities come to oscillate easily. Particularly, if microparticles are magnetized and excited to be oscillated in a magnetic field (see FIG. 37), impurities make almost no oscillation. As a result, only the signals from the molecule 101 combined with the oscillating receptor 100 are selectively detected.

It is also possible to eliminate the influence of impurities by providing each tether molecule with non-linear spring characteristics to excite the molecule to make characteristic oscillation having an oscillation frequency that is different from that of the oscillation generator, thereby measuring this characteristic oscillation.

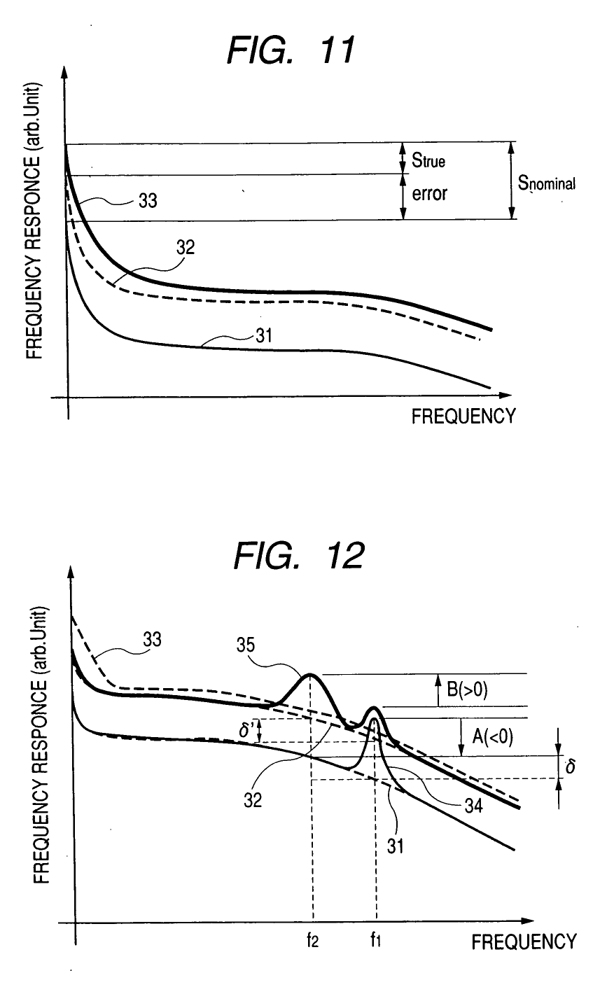

Next, a mechanism for improving the measurement accuracy will be described. In other words, a description will be made for how to reduce the error I_{Nnosp} caused by impurities. FIG. 11 is a graph for describing the influence of an error caused by impurities in a conventional method for comparison. The horizontal axis denotes a carrier modulation amplitude (response) output from the structure 2. Because no oscillation field is applied in any conventional method, a response at 0 Hz is assumed as a carrier response. The reason that frequency dependency is denoted here is to compare the error quantity between the conventional method and that of the present invention.

In FIG. 11, a curve 31 denotes a response before a sample is set. Sample setting means making a solvent or gas that contains an object substance 101 come into contact with the structure 2. The response curve 33 is that only for impurities. The curve 32 is a response curve assumed after a sample is set. The sample contains both object substance 101 and impurities (14). Many of the object substances are combined with the receptors to contribute for the response at an oscillation frequency of 0 Hz. Contribution of impurities also increases. The curve 32 denotes the contribution of impurities is increased when a sample is set. As understood by FIG. 11, a nominal amount of a combined substance detected by the conventional assay device is denoted as Sₙₒₘᵢₙₐₗ. The Sₙₒₘᵢₙₐₗ is shifted significantly from the Sₜᵣᵤₑ from which the error quantity contributed by impurities is excluded.

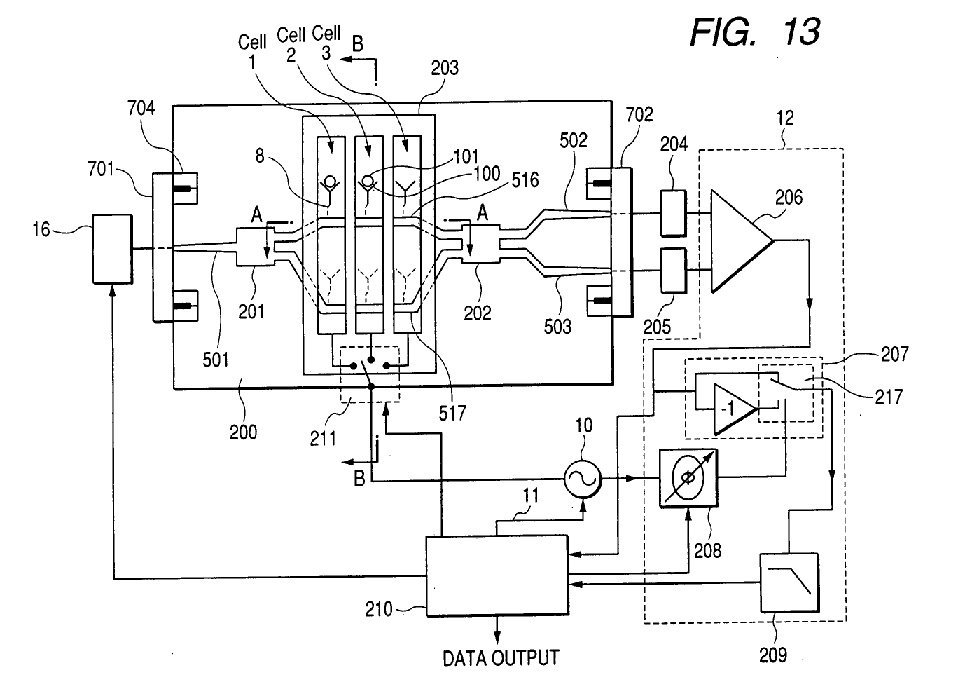

FIG. 12 is a graph for describing how to suppress the contribution of impurities according to the present invention. As in FIG. 11, the curves 34 and 35 denote oscillation frequency dependency of the response before and after a sample is set. The peak of the frequency f₁ in the curve 34 denotes a relaxation oscillation frequency or characteristic frequency of the receptor before the object substance is combined with the receptor. In order to enable the receptor to make characteristic oscillation, it is required to provide the tether molecule with spring characteristics. When a sample is set, the object substance 101 is combined with the receptor, whereby the relaxation oscillation frequency or characteristic oscillation frequency is shifted up to f₂. After the sample is set, a peak appears at both f₁ and f₂ respectively. This occurs because there are two receptors; one is coupled with the object substance and the other is not coupled with any substance.

In the case of the measuring method of the present invention, the amount of the object substance corresponds to (B-A)/2 in FIG. 12. This amount matches with the amount obtained by adding up the number of reduced receptors that are not combined with any object substance with the number of receptors increased and combined with the object substance, then dividing the result by 2. At that point, the number of measured value errors caused by impurities corresponds to half of the change of the response difference between oscillation frequencies f1 and f2, that is, (δ′−δ)/2 in FIG. 12.

This quantity is generally smaller than the “error quantity” in FIG. 11. This is because the oscillation frequencies f1 and f2 do not correspond to a resonance oscillation frequency (relaxation oscillation frequency or characteristic frequency) in a carrier response caused by impurities. The present invention can thus reduce the number of errors caused by impurities as described above.

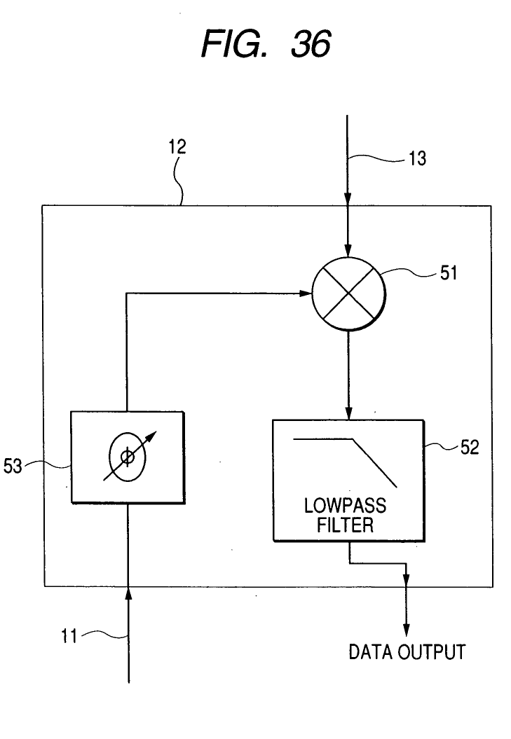

Next, a description will be made for the contents of the processing by the signal processing part 12 shown in FIG. 1 with reference to FIG. 36. The signal processing part 12 receives the modulation signal 13 from the carrier detector 5 and the synchronizing signal 11 from the oscillation field signal generator, respectively. The phase shifter 53 adjusts the phase of the synchronizing signal 11, which is then mixed with the modulation signal 13 in the mixer 51. The signal that is a result of the mixing passes through the low-pass filter 52 and then is output.

The above process can be described with some expressions as follows. The modulation signal 13 is A₀.sin(ωt+α) and the synchronizing signal 11 sin(ωt+β), where A₀ denotes an amplitude of the modulation signal, ω denotes an angular frequency of the oscillation field, t denotes a time, and α denotes a result of the extraction of low frequency components, are combined after obtaining a product between signal phase into A₀/2*cos(β−α)−A₀/2*cos (2ωt+α+β). This result goes through the low pass filter 52. A phase shifter 53 makes an adjustment to the synchronizing signal so that the phases β of synchronizing signal 11 and α of modulation signal 13 match with each other. As a result, a half amplitude A₀/2 of that of the modulation signal is output as signal data. The relaxation oscillation frequency, as well as the characteristic oscillation frequencies f1 and f2 are realized by adjusting the oscillation field angular frequency ω. The relationship between the oscillation frequency and the frequency becomes ω=2πf.

In order to measure an extremely small amount of biological substance quickly while the impurity density is high, the present invention uses no fluorescent marker and uses only a measuring substrate to achieve simple and low cost measurement.

### First Exemplary Embodiment

FIG. 13 shows a top view of an unlabeled biological sensor for measuring phase changes of a light transmitted through an optical waveguide in a first embodiment of the present invention. A Mach Zehnder Interferometer is formed with use of an optical waveguide provided on a conductive silicon substrate 200 having a thickness of 1 mm. The optical waveguide is 6 μm in width and designed so as to function as a single mode waveguide. The light output from a tunable light source 16 is inputted to an input optical waveguide 501 formed on the substrate 200 through a fiber connector 701. The light transmitted through the optical waveguide 501 is converged into two lights through a multimode interferometer (MMI) coupler. This converging MMI coupler 201 is 310 μm in length and 20 μm in width.

After the converging, an antibody 100 (that functions as a receptor) to be coupled selectively with an object substance 101 is immobilized on the surface of the optical waveguide 516. On the other hand, an antibody for comparison, which is not coupled with the object substance, is immobilized on the surface of the optical waveguide 517. The sensitivity and dynamic range for detecting biological substances increases/decreases in proportion to the increment/decrement of the length of the object optical waveguide provided in the region where an antibody is immobilized. In this embodiment, the selective antibody is immobilized in a 10 mm region.

A combining/diverging MMI coupler 202 is then used to cause light interference in order to measure a light phase change to occur due to the object substance combined with the receptor. The interfered light passes through the output optical waveguides 502 and 503, then the photodiodes 204 and 205, thereby converting the light intensity to a current flow through a fiber coupling connector 702. If the outputs from the photodiodes 204 and 205 are assumed as PD1 and PD2, the PD1 and PD2 are changed sinusoidally with respect to the light phase change, so that the light phase is shifted by π/2.

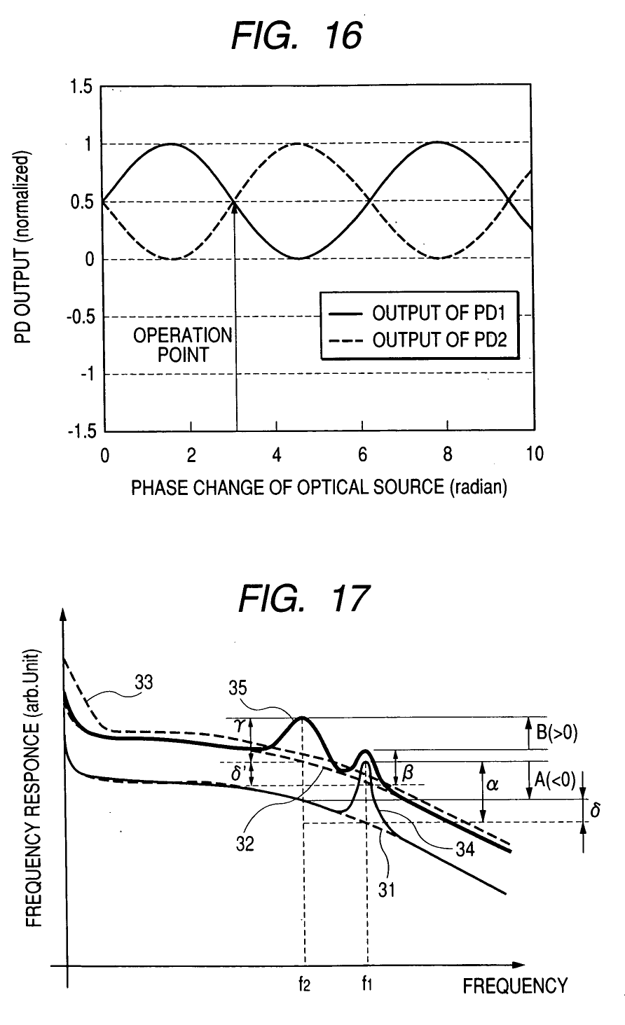

The sum of PD1 and PD2 is almost equal to the sum of the intensities of the lights transmitted through the optical waveguides 516 and 517. It is thus possible to adjust the wavelength of the light output from the tunable laser properly to set the light phase condition at each operation point. And, in order to enable such setting, a difference of 80 μm is generated between the lengths of the optical waveguides 516 and 517. Consequently, if a light having a communication wavelength 1.55 μm band is changed by 10 nm, the light phase condition can be changed by π and the phase adjustment is enabled within any phase condition and the maximum sensitivity condition. After such an adjustment, that is, around the operation point shown in FIG. 16, (A−B)/(A+B) is almost equal to the light phase change. This value can thus be assumed as a phase change output value.

Next, a method for setting an object sample to be detected (a solvent containing the object substance) will be described. The object substance must be in direct contact with the optical waveguides. In order to make the object substance contact with the waveguides, a silicon resin cell 203 is adhered on the substrate. The cell means a recess for holding the sample. In the cell, the sample is enabled to come into contact with the optical waveguides 516 and 517. In this embodiment, three cells are provided to measure three types of samples on the same substrate. Those cells are numbered as Cell 1, Cell 2, and Cell 3 in FIG. 13. The quantity of the sample to be set in one cell is about 10 μl.

Next, a method for processing the signal output from photodiodes will be described. The signal denotes a phase change output value. At first, an output difference between two photodiodes is amplified by a differential amplifier 206. The signal from the oscillation field signal generator 10 is adjusted for both power and phase properly to be used as a synchronizing signal. The synchronizing signal is input as a switch signal to a phase sensitive detector 217 provided in the synchronization detection circuit 207 that functions as a mixer. The sum frequency is then removed from the output of the phase sensitive detector 217 and passed through the low-pass filter 209 to limit the signal bandwidth. The control circuit 210 controls the adjustment of the synchronizing signal so that the maximum signal is output from the low-path filter.

The control circuit 210 also controls the adjustment of the phase of the light transmitted via each operation point shown in FIG. 16 so as to obtain the maximum output from the low-pass filter 207. In that connection, the control circuit 210 sends a wavelength control signal to a modulation variable light source 16. And, in order to obtain a signal from one of the Cells 1 to 3, the signal from the oscillation field signal generator 10 selects a cell given an oscillation field with use of the target cell select switch 211. For example, if an oscillation electric field is applied only to the Cell 2, only the receptor in the Cell 2 comes to oscillate, thereby the substance density in the Cell 2 is measured. According to the conventional method, combined signals in the cells disposed serially in the longitudinal direction of the optical waveguide are added up, so that the substance density in each cell cannot be measured separately.

Consequently, the substrate on which an optical waveguide Mach Zehnder Interferometer is formed comes to function as a sensor chip. On the substrate 200 is provided a structure for making this sensor chip disposable. This structure is a 704 V-groove one which is provided at end faces of optical fiber connectors 701 and 702 respectively. And, that structure enables those optical fiber connectors 701 and 702 to be aligned in position to two metallic pins. The fiber connectors 701 and 702 are removable.

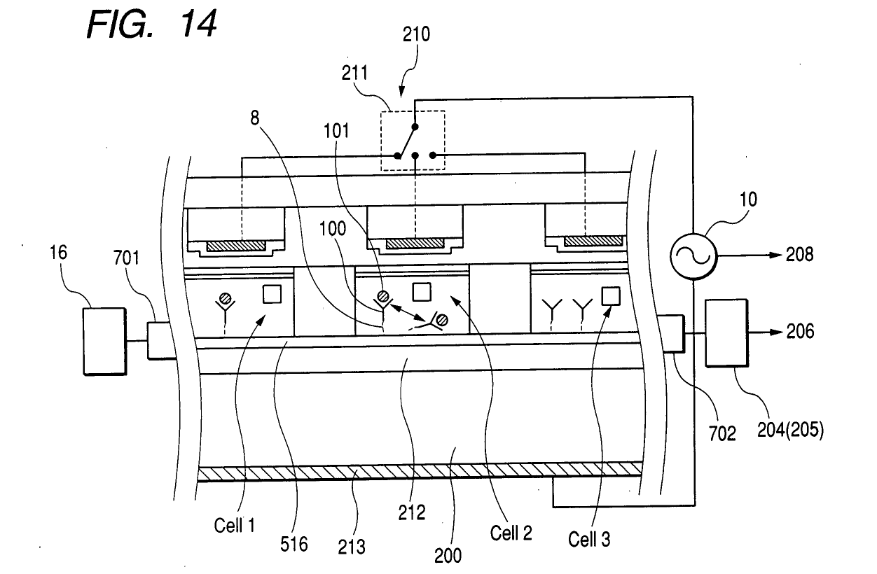

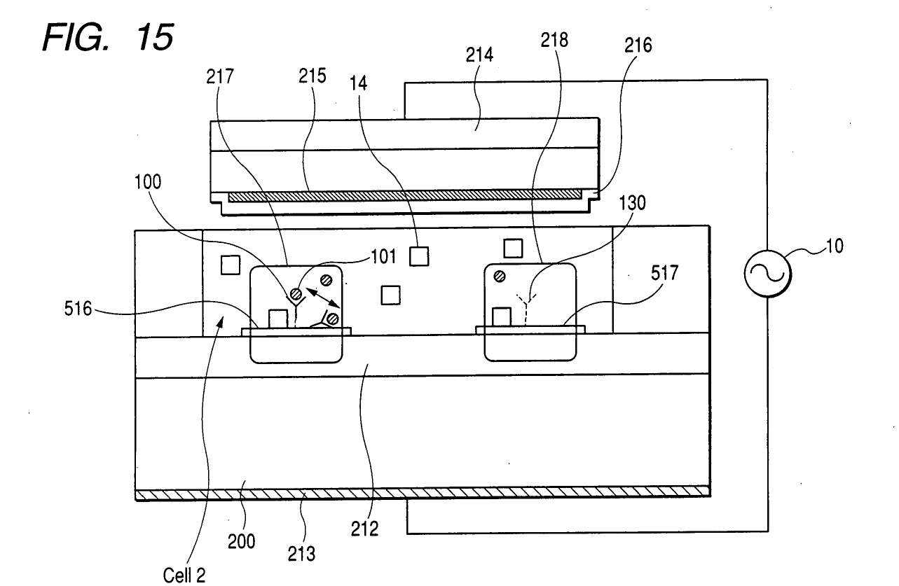

Next, a cross sectional structure of the sensor chip will be described. FIG. 14 shows a cross sectional view of the sensor chip through line A-A in FIG. 13. FIG. 15 shows a cross sectional view of the sensor chip through line B-B in FIG. 13. The cross sectional view in FIG. 14 is for an optical waveguide on which an antibody is selectively immobilized in the longitudinal direction. Such an optical waveguide is provided on the conductive silicon substrate 200 having a ground electrode 213 disposed on its rear side. A clad layer 212 on the substrate 200 is made of thermosetting polymer and a silicon nitride (Si₃N₄) thin film optical waveguide core layer 516 is formed thereon with use of the CVD (Chemical Vapor Deposition) method. The optical waveguide core layer 516 is 0.18 μm in thickness and 1.95 in refractive index. The optical waveguide core layer may be made of any of amorphous silicon (aSi), alumina (Al₂O₃), and aluminum nitride (AlN)

On the optical waveguide core layer 516 are disposed three sample Cells 1 to 3. A “wall” 203 of each cell is made of silicon rubber, which is extended by 3 mm in the longitudinal direction of the waveguide.

Next, a structure for applying an oscillation electrical field into the object solvent will be described. A molded insulating plastic jig 214 is disposed in the upper portion of each cell so as to enable an electrode 215 to be inserted in the cell (FIG. 15). An electrode protective film 216 suppresses the electrical chemical reaction on the surface of the electrode to ensure the chemical stability of the electrode. The structure that includes such electrodes functions as an oscillation field generator. In order to change a voltage generated from the oscillation field signal generator to a high electric field in the sample solvent, the gap between the electrode 215 and the optical waveguide core layer 516 is reduced up to about 0.2 mm.

Then, a receptor 100 is to be immobilized as follows. A silane coupling treatment is applied onto the silicon nitride film formed by the CVD method to form an amino (NH₂) group on the surface. As the silane coupling agent, 3-glycidoxypropyltrimethoxysilane is used to carry out a silane coupling treatment by dipping the substrate in this 1% solvent. The carboxyl (COOH) group existing at three ends of the 50-base single-chain DNA is then condensed into and coupled with this amino (NH₂) group. This single-chain DNA functions as a tether molecule 8. In addition, the carboxyl group of an anti-α Fetoprotein antibody is coupled with the amino (NH₂) group existing at each of 5 ends of this single-chain DNA.

An electric field between the electrodes 215 and 213 acts on the ion obtained on the surface of the ant-α Fetoprotein. The silicon substrate 200 is conductive, so an electric field is applied to between the electrode 215 and the substrate 200. Since the anti-α Fetoprotein is 20 nm in molecule size, this oscillation electric field application enables the center of gravity to make a bidirectional movement between the depths 23 nm and 3 nm from the surface of the optical waveguide core layer 516. Then, the phase change caused by this oscillation is measured. The weight of molecules is changed from 160,000 to 230,000 due to the AFP combining. Consequently, the molecule size changes, whereby the relaxation oscillation frequency changes. It is also possible to condense the carboxyl group in the anti-α Fetoprotein and couple it with the object after a silane coupling treatment. In that configuration, the tether molecules are omitted in this embodiment.

Next, a process for measuring an amount of combined AFP in a sample solvent will be described. Curves 34 and 35 denote frequency responses before and after a sample is set in a cell. Those frequency responses are obtained from the output of the low-pass filter 209 corresponding to the new frequency obtained by changing the frequency generated from the oscillation field signal generator 10. The peak of the oscillation frequency f1 in the curve 34 is a relaxation oscillation frequency of an AFP antibody before the AFP is combined. The oscillation frequency f2 in the curve 35 is a relaxation oscillation frequency of a composite of AFP and anti-AFP after the sample is set in a cell.

The amount of the object substance to be detected corresponds to (B-A)/2 in FIG. 17. This amount denotes the correspondence to the amount of combined AFP. The curves 31 and 32 denoted by a dotted line respectively denote the contribution of only impurities before and after sample setting. At that time, the decrement of the peak in the f1 is denoted by β-α and the increment of the peak at f2 is denoted by γ. A difference between frequency responses f1 and f2 caused by combined impurities is assumed as δ and δ′ before and after sample setting. At that time, the relationship between A/B and α, β, γ, δ, and δ′ becomes A=δ−β, B=γ+δ′, and B−A=γ+(β−α)+(δ−δ′).

The response caused by impurities does not denote any remarkable frequency dependency at f1 and f2. The response is represented as (δ−δ′)<<γ, β−α. And, because the increment of the peak by AFP combined at f2 is equal to the decrement of the peak at f1, the result becomes γ=β−α. After all, (B-A)/2 comes to correspond to the amount of combined AFP. Then, the curves 31 and 32 may be calculated by means of curve fitting in the control circuit 210 to obtain α, β, and γ directly so as to output the amount of combined AFP.

The cross sectional view shown in FIG. 15 will be described in more detail. Two optical waveguides 516 and 517 are formed in the configuration shown in FIG. 15 and they are used as an AFP detecting optical waveguide 516 and a reference optical waveguide 517. On the waveguide 516 is immobilized an anti-AFP antibody. On the waveguide 517 is immobilized selectively a standard antibody 130 for biomolecules (for example, Porphyrin Dendrimers) of which the density is already known. The biomolecules do not exist in the sample solvent originally, so that it is added into the solvent just before the measurement.

In the above description in this embodiment, Porphyrin Dendrimers is not added into the sample solvent (the density is known to be 0). Reference numerals 217 and 218 in FIG. 15 denote the field distributions of the light transmitted through the optical waveguides 516 and 517. Those light distributions leak into Cell 2 containing a sample solvent, and the intensity of each of the distributions decreases exponentially as they go far from the surface of the optical waveguide. Consequently, the light intensity comes to differ at a place where antibody molecules exist between when the object antibody lies on the optical waveguide and when it stands. Thus, the light intensity difference changes the phase of the transmission mode such a periodical electric field generates a light phase change, whereby the oscillation amplitude of the receptor can be converted to a light phase modulation amplitude.

Reference numeral 14 in FIG. 15 (and other figures) denotes impurities. The light phase changes due to the impurities stuck on the optical waveguides 516 and 517. If impurities move in the light field 218 around the surfaces of the optical waveguides while no impurity is attached, the movement causes light fluctuation, as well. This light fluctuation is caused by the Brownian motion of molecules, so that the frequency response is anti-parallel to the power of f. It is known that it results in 1/fα noise (1<α<2). Noise can thus be reduced by the lock-in measurement that uses molecule oscillation.

Next, the effect of this embodiment related to a method for realizing high measurement sensitivity will be described. The relative intensity noise I_{Nc} of the laser beam source 16 is under −130 dB. The sensor chip light output intensity (PD1+PD2) is 0 dBm to minimize the influence of the noise of the photo-detector and the differential amplifier. Under those conditions, the frequency of the oscillation electric field used for lock-in measurement is set at 10 kHz, thereby the I/f noise, of which factors are I_{Nstr} and I_{Nnosp}, can be reduced by two magnitudes.

When the phase change of a light transmitted through an optical waveguide is to be measured, the object sensor chip is required to adjust the temperature. In the case of the present invention, however, the temperature adjustment is required only for managing chemical reactions; other temperature adjusting mechanisms can be omitted.

Furthermore, just after the sample solvent is dripped onto the sensor chip, the surface reaction progresses and a large signal drift occurs. All of the conventional methods have thus been disabled for the measurement. According to the present method, such drift influence is eliminated, so that measurement can be started just after the sample is set.

Another effect of the present invention is that an object substance can be detected and the size (a liquid dynamic radius) of the detected molecules can be analyzed at the same time. In other words, in this configuration, the change of the relaxation oscillation frequency from f1 to f2 is employed when an AFP is combined selectively with an anti-AFP antibody. If other substances, i.e., impurities, are stuck on the antibody, the resonance frequency change level differs. This is why the influence of another substance combination is eliminated in the present invention. Furthermore, separate measurement is achievable for each of the cases in which a composite of a single AFP and another substance is combined with an anti-AFP and in which a single AFP is combined with the anti-AFP.

### Second Exemplary Embodiment

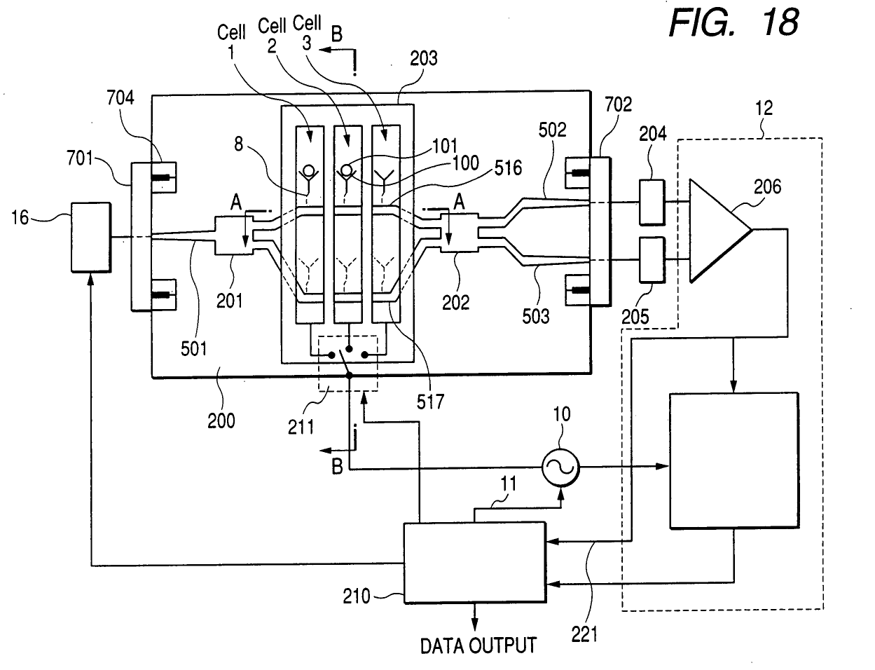

In this second embodiment, the means for measuring the oscillation of the antibody that is a receptor is different from that of the first embodiment. In other words, the method for the connection between the signal processing part 12 and the control circuit 210 differs between the first and second embodiments. FIG. 18 shows a top view of the configuration for measurement in this second embodiment. The control circuit 210 applies both frequency and amplitude of an oscillation field to the oscillation field signal generator 10. The laser beam from the tunable laser source interacts with an object substance and a receptor set on a sensor chip while two photo-detectors 204 and 205 receive the laser beam.

The laser beam is then input to a differential amplifier 206. The differential amplifier 206 amplifies the difference signal and normalizes the signal with a sum of two intensities, then outputs the signal. The signal is then inputted (221) to the control circuit 210, which controls the wavelength of the tunable laser source so as to obtain the maximum signal frequency component. When this control is ended, the output of the differential amplifier 206 is divided into intensity data for each frequency component within a wide frequency range including the frequency of the oscillation field to be output to the control circuit 210. Then, the data is output corresponding to the oscillation field supplying cell number.

### Third Exemplary Embodiment

In this third embodiment, changes of the rise time of the oscillation of a receptor and the rise time of the oscillation of a composite of a receptor and an object substance are measured to eliminate the influence of impurities.

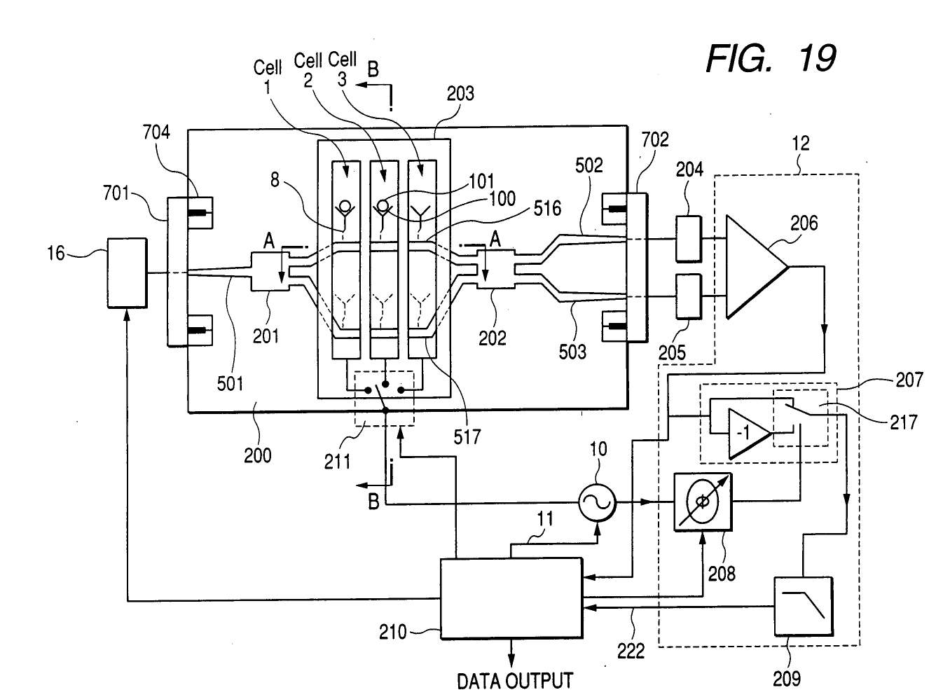

FIG. 19 shows a top view of the configuration of this third embodiment. Also in this third embodiment, the control circuit 210 applies signals of both frequency and amplitude of an oscillation field to the oscillation field signal generator 10. After that, as in the second embodiment, the laser beam from the tunable laser source interacts with the object substance and the receptor set on the sensor chip, respectively, whereby a current corresponding to the laser beam intensity in each of two photo-detectors 204 and 205 is input to the differential amplifier 206. The differential amplifier 206 amplifies the difference signal, normalizes the signal with a sum of two intensities, and then outputs the signal. This signal is then input to the control circuit 210, which controls the wavelength of the tunable laser source so as to obtain the maximum amplitude.

When this control is ended, both of the molecule relaxation oscillation frequency and the weight of molecules in the relaxation oscillation are measured by sweeping the duty of the excitation oscillation electric field, not by sweeping the frequency.

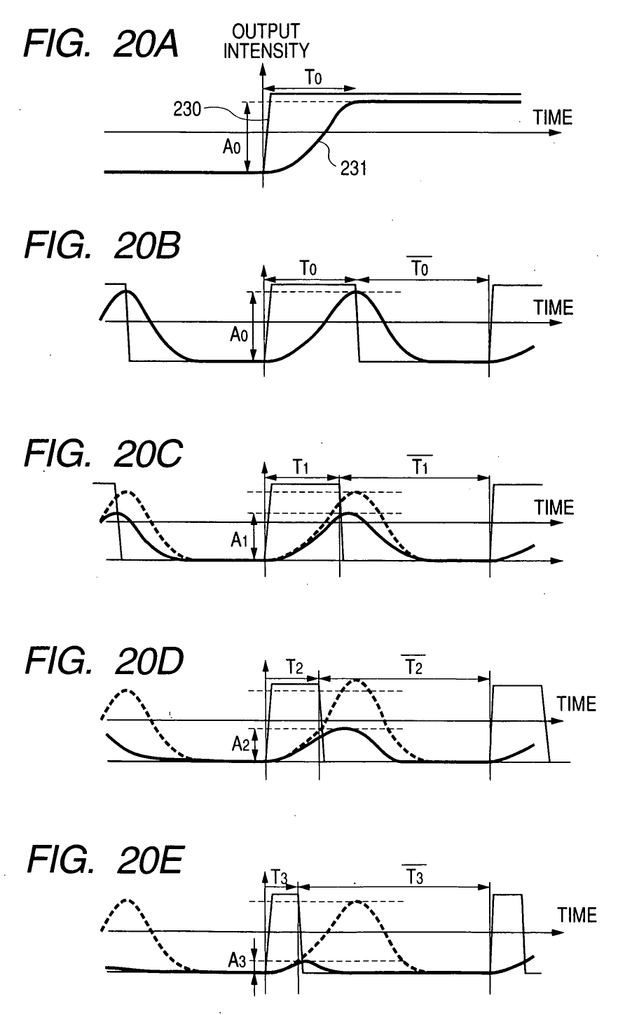

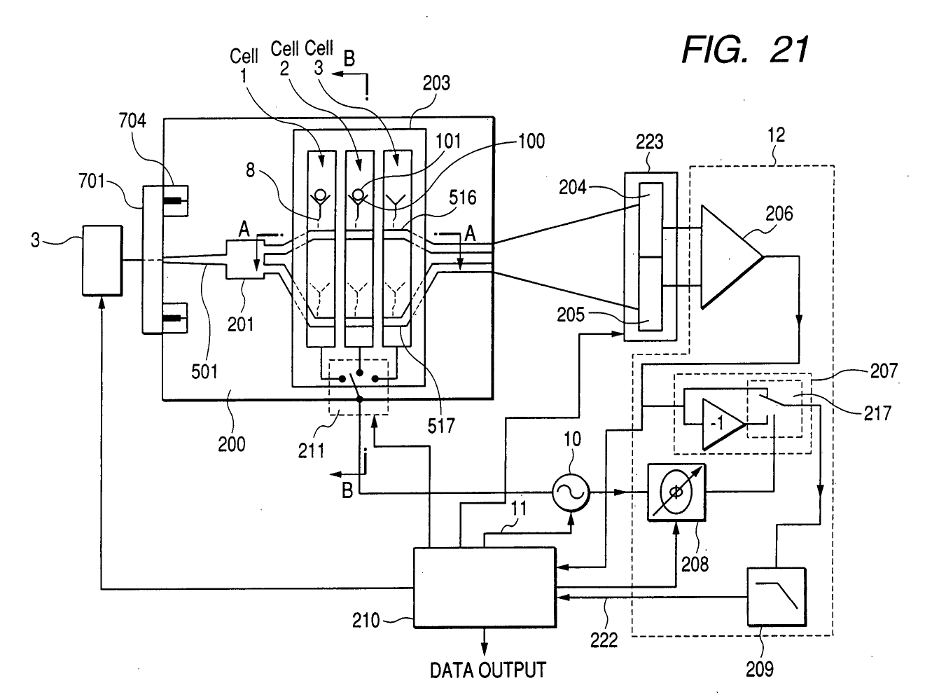

At first, a simple case for the above operation will be described. The excitation oscillation frequency is decreased so that the receptor and/or composite of the receptor and the object substance can follow it. According to the rising of the oscillation electric field denoted in the curve in FIG. 20A, the differential amplifier output signal is delayed by a time T₀ to rise as denoted in the curve 231 (compared to line 230). At that time, the larger the hydrodynamic radius of molecules, the more the rise time is delayed. Consequently, the anti-AFP antibody is coupled with the AFP to increase the T₀, whereby the size of the coupled molecules is identified.

Hereunder, a description will be made for how to measure an amount of combined molecules according to such a rise time. This method can also be applied to a case in which a plurality of different kinds of molecules are immobilized on a waveguide. As shown in FIG. 20B through FIG. 20E, the high level time of an oscillation field is shortened as T₀→T₁→T₂→T₃. Consequently, molecule movement cannot keep up with the electric field, so that the differential amplifier output peak is changed as A₀→A₁→A₂→A₃.

Here, A₀ is identical to the response to a step function (230) in FIG. 20A, so that T₀ is determined as a response time. The weight of molecules capable of responding at T₀ and later comes to be proportional to A₀. Consequently, the continuous high level time is swept like T₀→T₁→T₂→T₃ so that the weight of molecules, when the response time is between T1 and T2, is proportional to A₁-A₂. In this way, the weight of molecules at each response time can be measured by sweeping the duty ratio of the continuous high level time, that is, a rectangular wave. In other words, it comes to be possible to measure an amount of substance in each size of molecules stuck on the surface of the object optical waveguide.

### Fourth Exemplary Embodiment

In this fourth embodiment, an interference pattern formed on the light receiving surface of the object photo-detector is measured, and no Mach Zehnder Interferometer is formed on a sensor chip with use of an optical waveguide. FIG. 21 shows a top view of a configuration of this fourth embodiment. The laser beam from the laser beam source 3 is injected into an optical waveguide 501 provided on a substrate 200, and the laser beam is then converged into a detection optical waveguide 516 and a reference optical waveguide 517 as in the first embodiment. Those laser beams are taken out from the substrate. The laser beams interfere with each other in the photo-detectors 204 and 205 to form an interference fringe. The photo-detectors 204 and 205 are disposed to minimize the gap therebetween so that their light receiving surfaces are combined into one surface. Those photo-detectors are disposed on a movable stage 223 and controlled so as to obtain the maximum intensity difference between the photo-detectors 204 and 205.

The photo-detectors are controlled concretely as follows. The outputs of the two photo-detectors 204 and 205 are inputted to a differential amplifier 206. The differential amplifier amplifies the difference signal, normalizes the signal with a sum of two intensities, and then outputs the signal. This signal is inputted (222) to the control circuit 210, which then controls the movable stage 223 so as to raise the signal amplitude up to the maximum. The control signal corresponds to the object substance to be detected just like in the first embodiment.

### Fifth Exemplary Embodiment

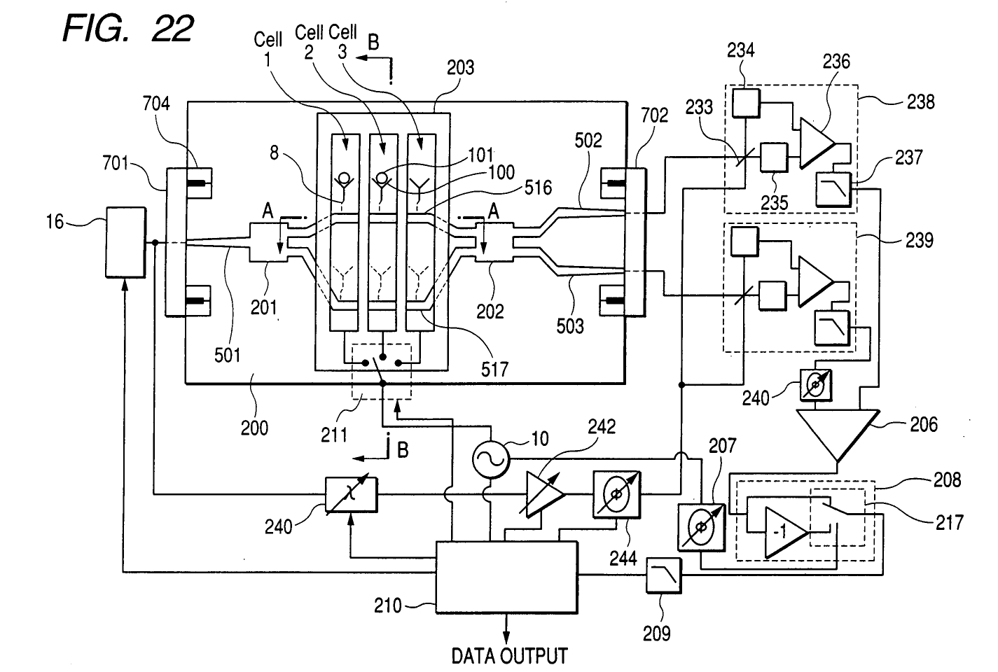

This fifth embodiment uses a light heterodyne detecting method. FIG. 22 shows a configuration of this fifth embodiment. In this fifth embodiment, the wavelength of an object light signal is shifted to amplify the intensity and adjust the phase of the light signal, and then measure the signal with use of a balanced detector. The wavelength-adjusted light is then input to the balanced detector as a light of a local light source to reduce the influence of thermal noise generated when the light is received and amplified.

FIG. 22 shows a exemplary configuration to achieve this object. The laser beam from a tunable laser beam source is divided into two waves and one wave is inputted to an optical waveguide 501 so that the beam interacts with a receptor and an object substance set on the substrate respectively. The other wave is further divided into two waves and their wavelengths are modulated by a wavelength changer 240. A concrete example of the wavelength changer 240 is an acoustic/optical effect element. Here, it is assumed that the wavelength of the laser beam output from the tunable laser beam source is λ₀ and the wavelength of the laser beam is λ₁ after the wavelength is changed by the wavelength changer 240. After the wavelength change, the light amplifier 242 amplifies the intensity and the phase shifter 244 adjusts the phase of the laser beam, respectively. Those laser beams are then inputted to the balanced detectors 238 and 239 as the lights of local light sources. Those two balanced detectors correspond to the photo-detectors 204 and 205 in FIG. 13.

Hereunder, the balanced detector 238 will be described. The lights from both of the optical waveguide 502 and the local light source, after the wavelength is changed by the wavelength changer 240, are combined/converged by a half mirror 233, and then converted to electrical signals by the photo-detectors 234 and 235. The electrical signals are then amplified by a differential amplifier 236 and are passed through a low-pass filter 237 to extract only the difference frequency between λ₀ and λ₁. The phase difference obtained from between the two balanced detectors 238 and 239 is adjusted in the phase adjuster 240, and the result is amplified in the differential amplifier 206. After that, the signal processing is done for the difference signal the same as in the first embodiment.

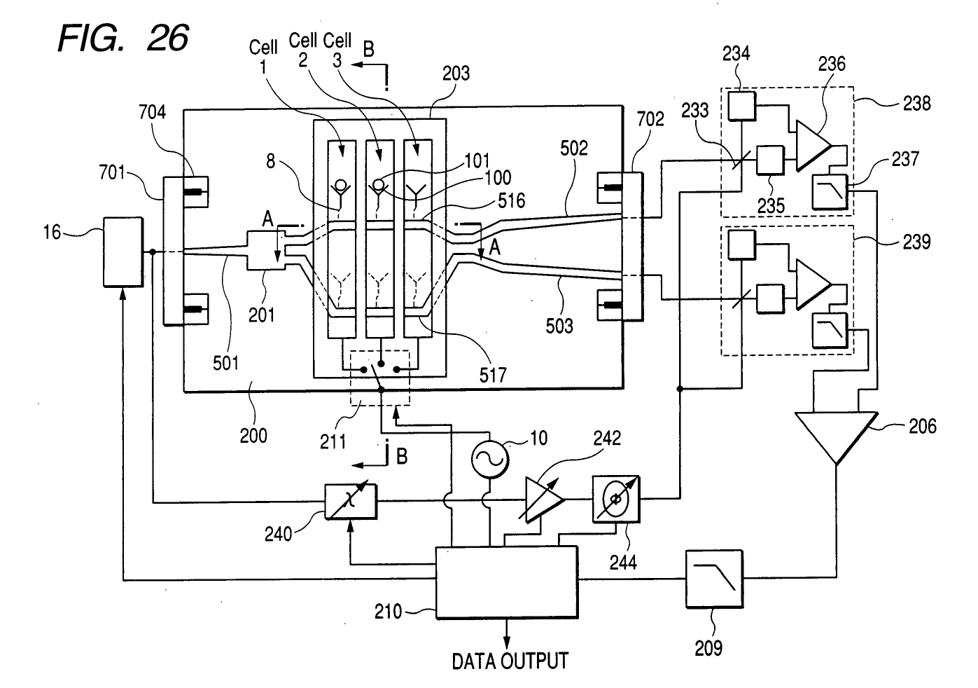

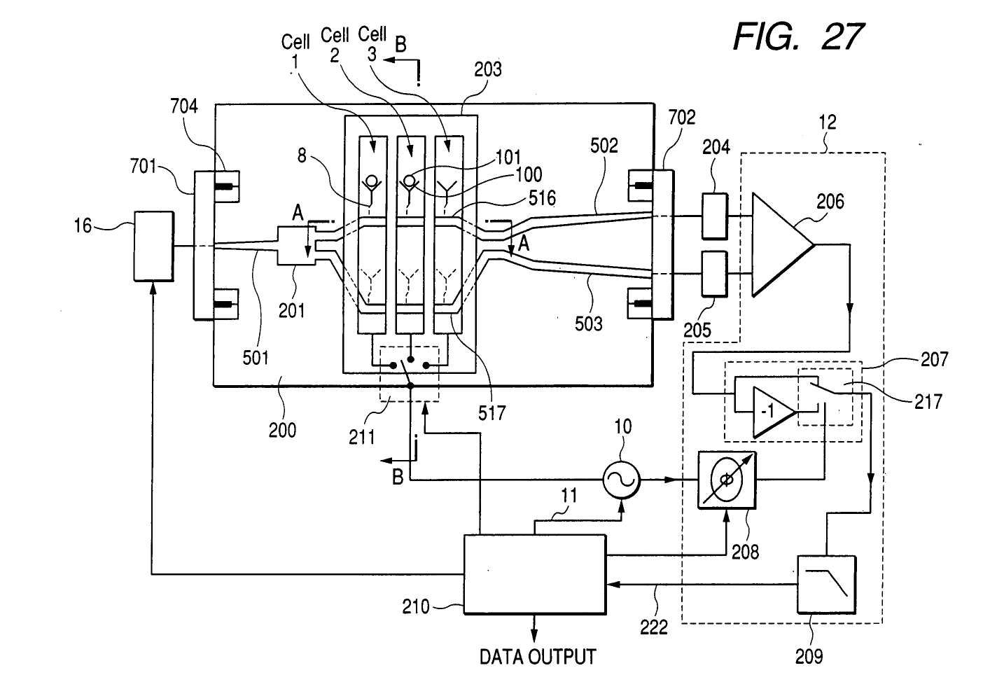

FIG. 26 shows another example of the heterodyne method. In this configuration, no light is combined/converged on the sensor chip. This method measures light phase changes to be caused by a receptor and an object substance with use of balanced detectors. Just like in the above case, the wavelength of part of the light from the light source 16 is changed and the result is assumed as λ1. It is then inputted to the balanced detectors 238 and 239 as a light of a local light source respectively. At that time, if the receptor excitation frequency is ω, the frequencies output from the balanced detectors 238 and 239 become 2π/λ₀−2π/λ₁+/−ω. λ₁ is then adjusted to obtain 0 as a differential frequency. After that, the sum frequency is cut off by a low-pass filter 209 to realize the above lock-in detection.

### Sixth Exemplary Embodiment

This sixth embodiment describes molecule movement which is different from those of the above embodiments. In the above embodiments, the receptor oscillation is of the relaxation type. Relaxation oscillation means oscillation of molecules that can move almost freely under the influence of an oscillation excitation field. In this sixth embodiment, each tether molecule that can couple a receptor with a surface of an optical waveguide is provided with spring characteristics. The receptor is thus oscillated characteristically in accordance with a specific frequency in an oscillation excitation field.

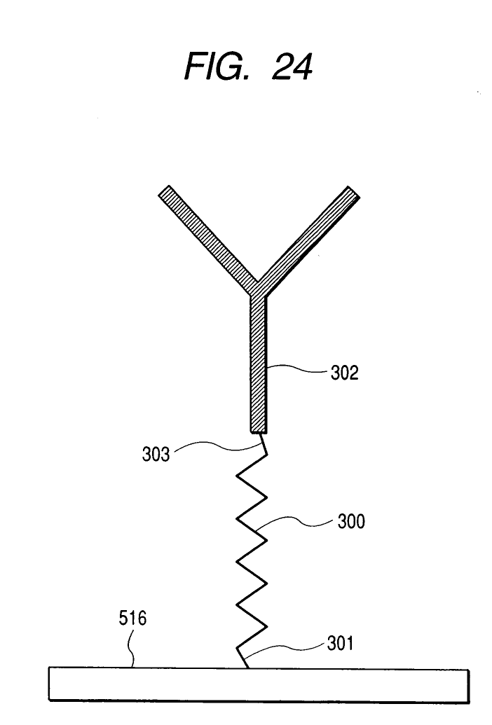

There are many known molecules having such spring characteristics. The polyethylene-glycol has a spring constant of about 10⁻⁵ to 10⁻³ N/m in a physiological salt solution. Consequently, if an anti-AFP antibody (molecular weight 160,000) is immobilized at a tip of the polyethylene glycol, the characteristic oscillation becomes 30 to 300 MHz. The characteristic oscillation frequency can be adjusted by applying a bias voltage to the oscillation field. FIG. 24 shows an explanatory view of the polyethylene glycol and the anti-AFP antibody immobilized on the optical waveguide 516. At a tip (301) of the polyethylene glycol 300 is disposed a thiol group and immobilized on the object optical waveguide with use of a silane coupling agent. Then, the anti-AFP antibody 302 is immobilized at the other tip from that which the polyethylene glycol was immobilized. A silane coupling agent 303 is used for this coupling through an amino group contained in the rizine in the antibody.

DNA and/or carbon nanotube may also be used as a material having spring characteristics. A receptor other than antibodies may also be used for the material. Another method may be used for the coupling between the antibody and a spring molecule, as well as between the spring molecule and the optical waveguide.

As described above, if oscillation is converted to relaxation type, the response frequency peak shift value is changed by a molecule weight, not by a molecule size. In other words, both of the number of molecules and a weight of molecules can be measured at the same time.

This measurement example can apply to any of the above first through fifth embodiments.

### Seventh Exemplary Embodiment

In this seventh embodiment, the influence of fluctuation from impurities is eliminated by using non-linear properties of a spring in each embodiment in which characteristic oscillation is measured. In each of the above embodiments, the excitation oscillation frequency and the measurement oscillation frequency are almost identical. At that constitution, many impurities oscillate at the same frequency. Consequently, if a response oscillation frequency other than the excitation oscillation frequency can be measured, the influence of impurities can be eliminated completely.

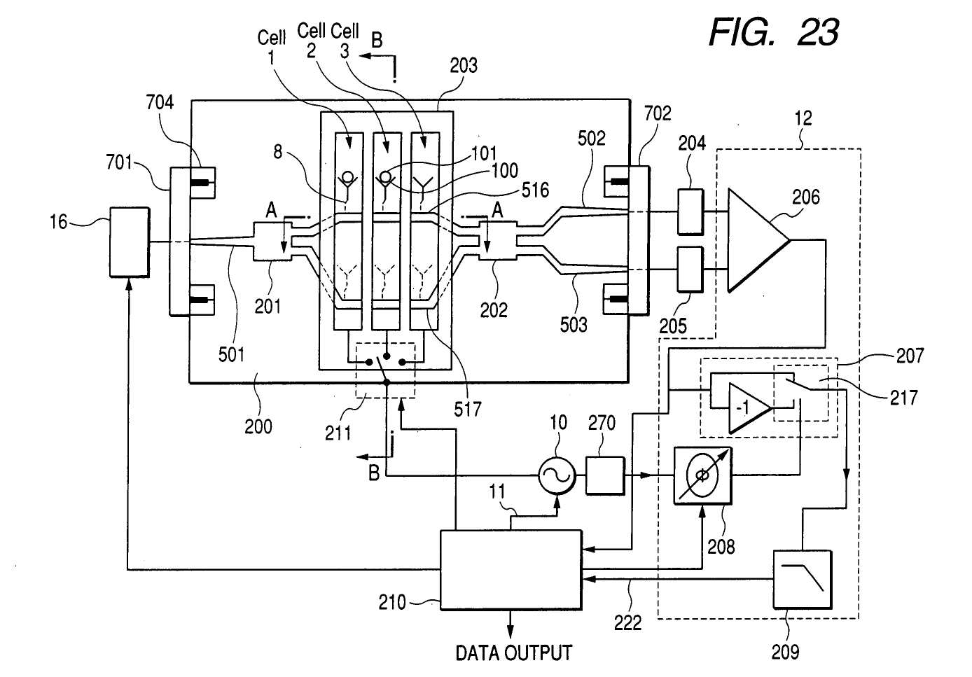

A large non-linearity can be set naturally for a spring constant by increasing the amplitude of the object oscillation electrical field. One of the methods effective for using such non-linearity is to set an integer multiple, or the same value as the characteristic oscillation frequency, for the frequency of the excitation oscillation field. For example, it is effective to apply an excitation field of the oscillation frequency of double or ½ of the characteristic oscillation frequency to the object. At that constitution, as shown in FIG. 23, the frequency of the excitation oscillation field to be mixed with the output signal from the differential amplifier when in lock-in measurement is converted to that of ½ or double in the frequency changer 270.

### Eighth Exemplary Embodiment

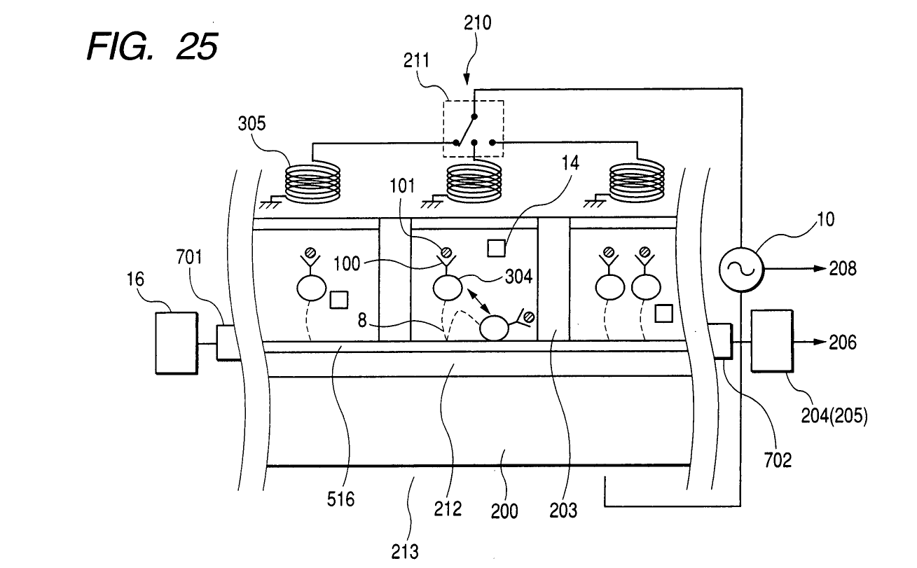

In this eighth embodiment, a magnetic field is used to excite the oscillation of the object receptor; no electric field is used for the same. FIG. 25 shows a cross sectional view corresponding to that in the first embodiment (FIG. 14). The oscillation excitation electrode 215 is replaced with a coil 305. Ferromagnetic 50 nm F₃0₄ microparticles are immobilized between the anti-AFP antibody and DNA that is tether molecules to oscillate the molecules in response to a magnetic field. A silane coupling agent is used for the coupling between the anti-AFP antibody and the DNA just like in the above embodiments. Because a magnetic field is used to excite the oscillation such way, the oscillation of impurities is minimized.

### Ninth Exemplary Embodiment

In this ninth embodiment, intensity changes of a light, which is caused by receptor movement, is used. The light is transmitted through an optical waveguide. In each of the above embodiments, phase changes of a light, which is caused by oscillation of a receptor or similar element, is used.

FIG. 27 shows a top view of a configuration of this ninth embodiment. A light emitted from a tunable light source 16 is input to a waveguide 501 provided on a sensor chip. The light is then divided by a branching filter 201 and a receptor 100 to be coupled selectively with an object substance 101 is immobilized on an optical waveguide 516. At that connection, nanometer size microparticles formed with a material that absorbs light from a light source efficiently are immobilized between the tether molecule 8 and the receptor 100. The microparticles are 50 nm in diameter and made of Fe₃O₄. The material of the microparticles may also be impurity-doped Si, ZnS, silica, ZnSe, CdS, CdSe, GaAs, or the like.

On the reference waveguide 517 is a receptor that is not selectively combined with any object substance is immobilized through microparticles. The light intensity from each of the optical waveguides 516 and 517 is converted to an electric signal in a detector, and then the signal is subjected to a lock-in measurement as in the first embodiment. The size and quantity of the molecules of the object substance can be measured as a light intensity change according to a change of both amplitude and frequency of a relaxation oscillation of the microparticles. Similarly, the tether molecule 8 may be replaced with polyethylene glycol that is a spring molecule to observe characteristic oscillation changes and measure both weight and quantity of molecules.

### Tenth Exemplary Embodiment

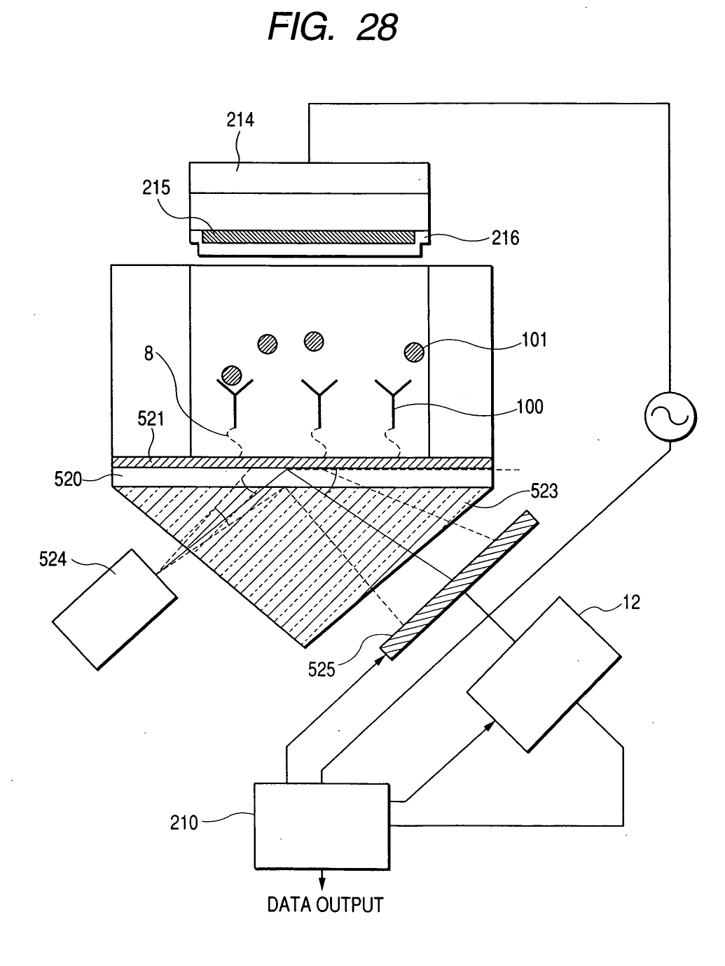

In this tenth embodiment, refractive index changes around a metallic thin film, which are caused by surface plasmon, are used for measurement. FIG. 28 shows a configuration for the measurement in this tenth embodiment. A receptor 100 is immobilized on a metallic thin film 521 with use of tether molecules 8. The receptor can thus go up/down due to an electric field generated by the oscillation excitation electrode 215. This up/down movement causes a refractive index change on the surface of the metallic thin film as in the first embodiment, whereby the excitation angle or wavelength of the surface plasmon changes.

This tenth embodiment uses a phenomenon that an angle change at which the reflection light intensity becomes weak due to the excited surface plasmon. In other words, an image pick-up device 525 detects such an angle change to be caused by the motion of the receptor. After that, the control circuit 210 sends a signal to the image pick-up device 525, which then selects two proper pixels (or two pixel groups) from the image pick-up device so as to obtain the maximum output from the signal processing part 12. The two pixels (two pixel groups) are then output to the signal processing part 12. The inside structure of the signal processing part 12 is the same as that in FIG. 13.

In the above configuration, DNA is used as the tether molecule to enable the receptor relaxation oscillation. However, the tether molecule may be replaced with polyethylene glycol to enable the receptor characteristic oscillation. Of course, the weight of the molecules in the object substance can be measured in this case as described above, as well.

While a charged receptor is used to excite the oscillation in each of the above embodiments, ferromagnetic Fe₃O₄ microparticles may be inserted between the receptor and the tether molecule to enable a magnetic field to excite the oscillation.

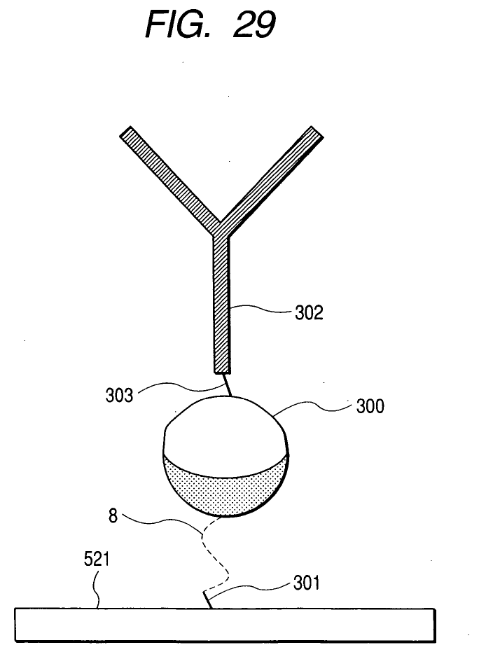

Furthermore, a metallic thin film may be deposited on the surfaces of microparticles or the metallic thin film may be inserted between the receptor and the tether molecule to excite surface plasmons between the surface of the metallic thin film and microparticles resonantly to improve the observation sensitivity. The surface plasmon excitation frequency changes according to a change of the distance between the microparticle 300 and the metallic thin film when microparticles are immobilized as shown in FIG. 29.

On the surfaces of those microparticles 300 are deposited a metallic thin film and metallic microparticles or metal. If the gap between the metallic thin film and the metallic microparticle is nearly under a few hundreds of nm, plasmon is excited strongly between the surface of the metallic thin film and the metallic microparticle. The receptor movement can thus be measured by measuring the wavelength change of the excited plasmon. The metallic microparticles should preferably be deposited so that the metal is deposited only on the lower half as shown in FIG. 29 so as to excite the surface plasmon more stably.

### Eleventh Exemplary Embodiment

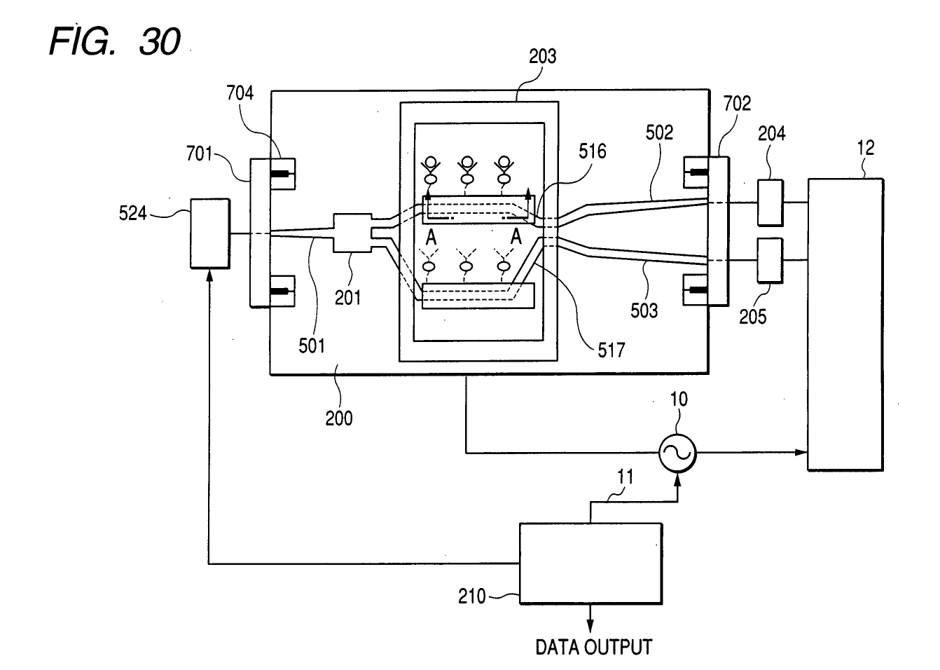

In this eleventh embodiment, the surface plasmon excited on an optical waveguide and/or optical fiber is used for measurement. FIG. 30 shows a configuration for the measurement in this eleventh embodiment. The configuration in this eleventh embodiment is similar to that in the ninth embodiment (FIG. 27) except that a metallic thin film for exciting surface plasmon is provided on the surface of an optical waveguide.

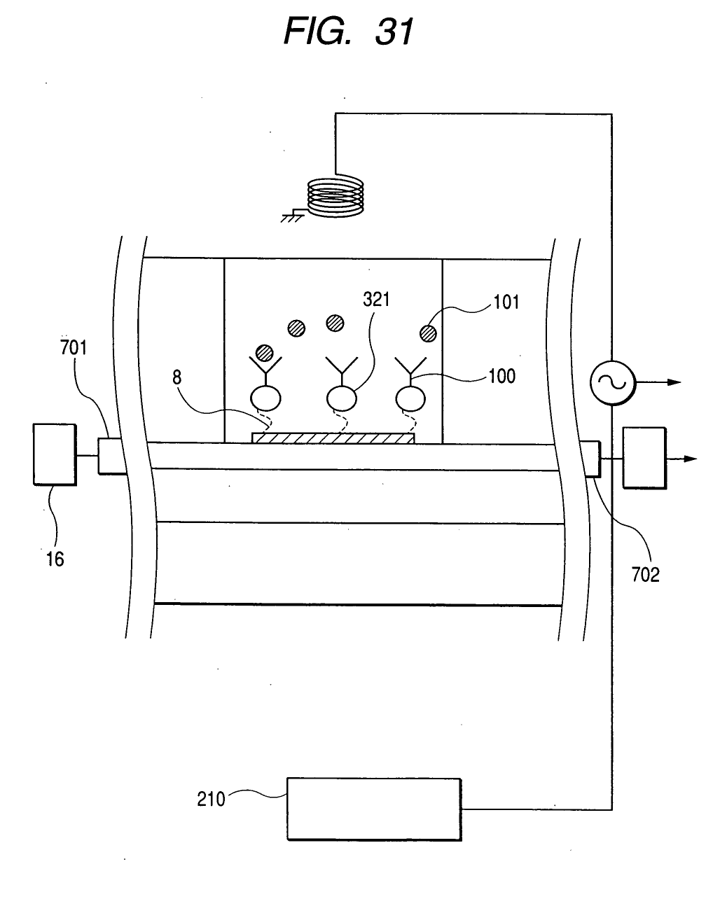

The light source 524 may be any of a laser one and an LED one. A photo-detector 204 detects falling of the light intensity to be caused by excited surface plasmon. The metallic thin film provided in the optical waveguide 517 is formed for reference signals. FIG. 31 shows a cross sectional view at an A-A line. In this embodiment, microparticles 321 having a gold-deposited Fe₃O₄ surface are immobilized between the receptor 100 and the tether molecule 8 to satisfy both oscillation excitation by a magnetic field and an increase of the surface plasmon effect.

### Twelfth Exemplary Embodiment

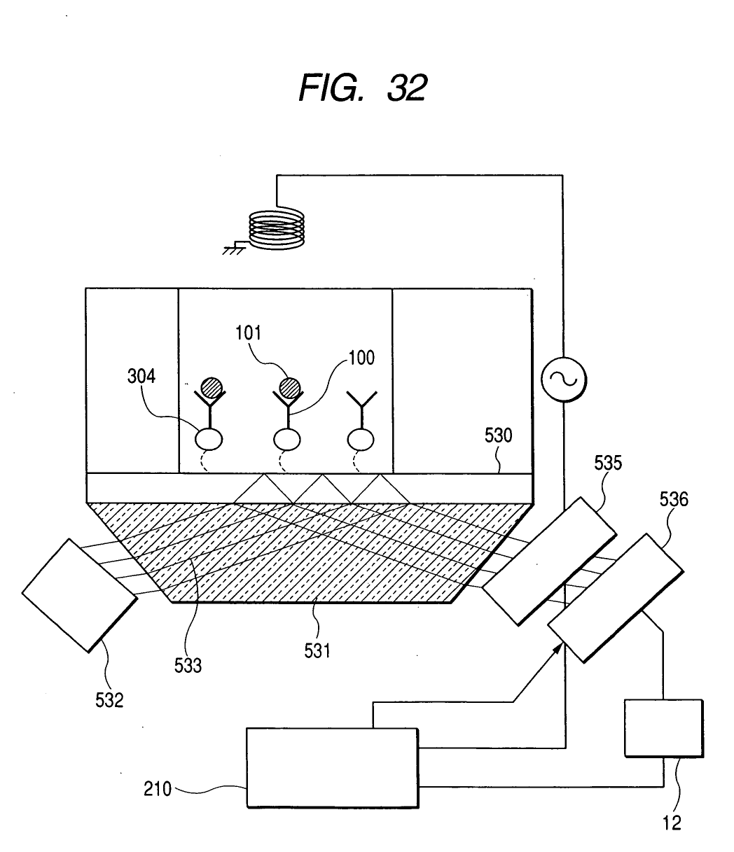

In this twelfth embodiment, resonant reflection of a light in a thin film is used for measurement. FIG. 32 shows a configuration of this twelfth embodiment. Ferromagnetic microparticles (Fe₃O₄) 304 are immobilized between the receptor 100 and the tether molecule to oscillate the receptor in an oscillation magnetic field. In this embodiment, refractive index changes to occur around the surface of a dielectric thin film 530 are measured according to reflection light spectrum changes. Among the lights passing a spectroscope 535, two pixels (two pixel regions) of an image pick-up device are selected and output to a signal processing part. The inside structure of the signal processing part is similar to reference numeral 12 shown in FIG. 13.

### Thirteenth Exemplary Embodiment

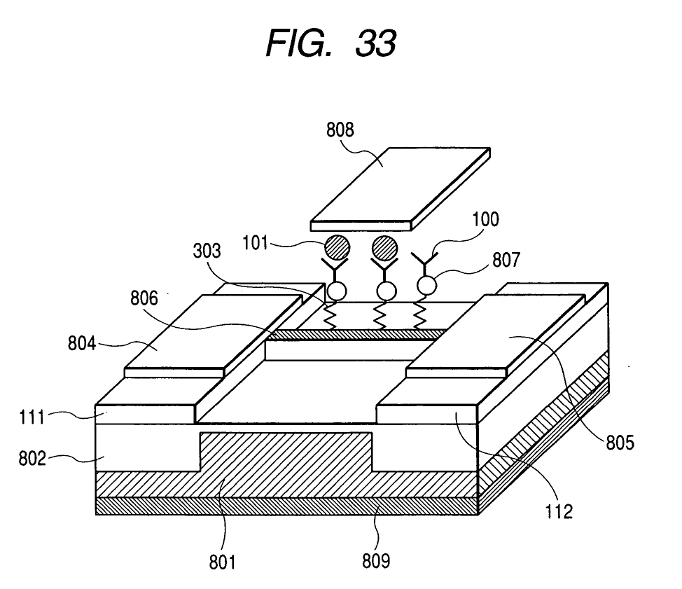

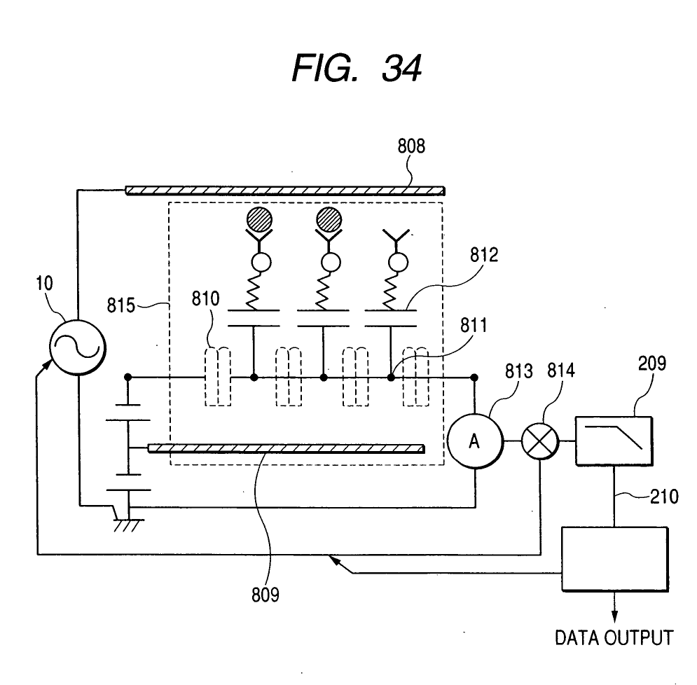

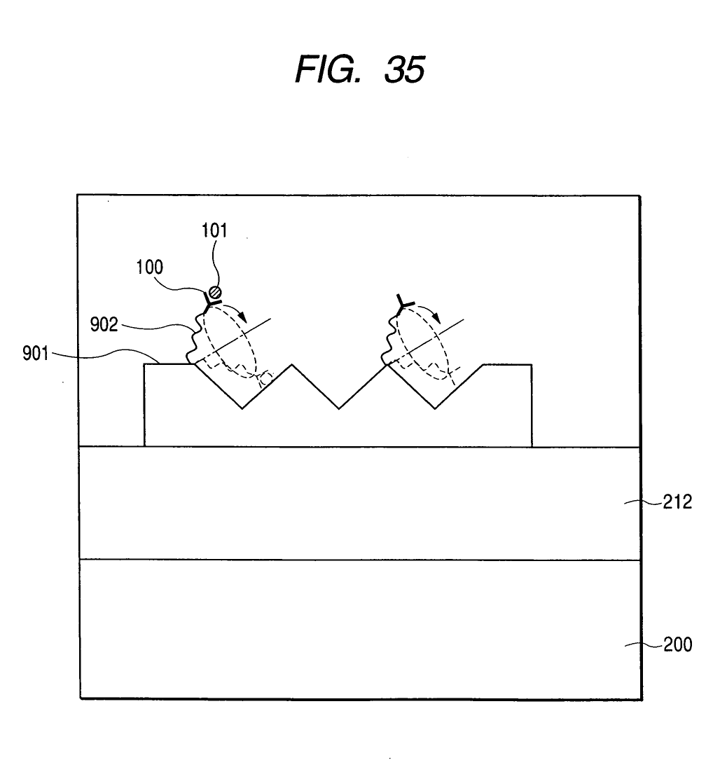

In this thirteenth embodiment, field effect transistors (FETs), particularly single electron effects are used for measurement. FIG. 33 shows a top view of a sensor chip in this thirteenth embodiment. FIG. 34 shows a configuration that includes the sensor chip. Initially, the structure of the sensor chip and measurement principles of the sensor chip will be described.

A thermal oxide film 802 is formed on a p-type silicon substrate 801. Then, layers 111 and 112 are formed consecutively with low resistance n-type polysilicon on the surface. Reference numerals 111 and 112 denote a source and a drain, respectively. A channel layer 806 is formed by an undoped polysilicon layer. The channel is 30 nm in thickness and 120 in width. Reduction of both thickness and width of the channel can improve the detection sensitivity. Thereafter, anti-AFP antibody 100 that is a receptor is immobilized on the top surface of the channel layer 806. At that connection, silica microparticles 807 are inserted between the channel layer 806 and the antibody 100 as shown in FIG. 33. On the surfaces of those silica microparticles 807 are immobilized a lot of negative ions obtained from polyethylene glycol (weight of molecules 6000) that are spring molecules. And, a silane coupling agent is used for the coupling between those molecules and microparticles.

If the receptor begins oscillation due to a voltage applied to the vibration excitation electrode 808, dielectric microparticles go closer to/away from the channel layer 806 repetitively. Consequently, the current flowing in the channel decreases, whereby the receptor movement is measured. This is why an object substance 101 is detected from a characteristic oscillation change. As in the measuring method employed in each of the above embodiments, the output from the current meter 813 and the oscillation excitation signal are mixed in the mixing circuit 814 to extract only the difference frequency signal through a low-pass filter 209.

In this thirteenth embodiment, single electron effects are used as a mechanism for changing the current flowing in a channel as described above. This effect makes it possible to improve the measurement sensitivity up to one molecule level. The channel layer 806 formed with undoped polysilicon can be regarded as a congregation consisting of many visible microparticles having a diameter of a few nm respectively. The gap between microparticles functions as a barrier for electrons to be transmitted. When a current flows in the channel layer, therefore, electrons are transmitted between microparticles. The channel layer is not doped and microparticles are so small that the number of transmitted electrons existing in a microparticle is 0 or 1. Consequently, if an electric doublet or charge (negative charge in this embodiment) gather closely around the channel layer, the electrons are shut off by both Coulomb interaction and the single electron effect.

The sensor chip may have a circuit diagram as shown with 815 in FIG. 34. Polysilicon microparticles in the channel layer are nodes 811, the barrier between microparticles is a tunnel wall 810, and spring molecules, receptors, etc. that are insulated electrically are immobilized around those articles. Any of the tunnel effect and the thermal excitation may be employed as the principle for passing electrons through the barrier wall. The bias control electrode 809 is used to control the state of the channel layer and the oscillation state of spring molecules.

The channel layer in this embodiment may be an inverted layer used normally in field effect transistors (FETs). Although both width and thickness of the channel layer are narrow, a larger current change rate may be set for less charge movement on the surface, whereby the measurement sensitivity is improved.

Furthermore, although microparticles used in this embodiment are qualified with negatively ionized molecules, such microparticles are not necessarily disposed for measurement, since receptors and object substances are often ionized. However, microparticles are effective to improve the measurement sensitivity. This is why this embodiment is described as a favorable embodiment.

### Fourteenth Exemplary Embodiment

This fourteenth embodiment of the present invention relates to another possibility of receptor movement. FIG. 35 shows a cross sectional view of a portion around a layer corresponding to an optical waveguide/dielectric thin film/channel layer in each of the above embodiments. In this embodiment, the surface of the thin film optical waveguide is formed unevenly 901 to enable a receptor to enter a region having light intensity distribution as strong as possible.

Molecules 902 employed in this embodiment are structured as spring molecules that twist in rotation like DNA when they are extended. As shown in FIG. 35, the receptor 100 is set to make a circular motion. If the thin film surface is smooth, the light is not modulated even when such a motion is excited. However, if the thin film surface is roughened (901), the receptor motion can be measured in a wide range. And, the state of a circular motion can be changed by an oscillation excitation field. An object substance 101 combined with a receptor can be detected by measuring a phase change and/or intensity change of a light transmitted through an optical waveguide.

Nothing in the above description is meant to limit the present invention to any specific materials, geometry, or orientation of elements. Many part/orientation substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered only to facilitate comprehension of the invention and should not be construed to limit the scope thereof.

What is claimed is:

1. A detection system for biological substances, which detects an object substance contained in a fluid being in contact with an optical waveguide formed on a substrate, said system comprising:
light injecting means for injecting a light into said optical waveguide;
light detecting means for detecting said light output from said optical waveguide;
a receptor disposed near a surface of said optical waveguide to be selectively coupled with said object substance;
oscillation excitation means for applying oscillation to said receptor to change a distance between said receptor and said surface of said optical waveguide; and
a signal processing part for calculating any of the amplitude, frequency, and/or phase of the oscillation of said receptor excited by said oscillation excitation means.

2. The system according to claim 1, further comprising:
a microparticle coupled with said receptor and sensitive to an electromagnetic field generated by said oscillation excitation means; and
a tether molecule to tether said receptor near said surface of said optical waveguide.

3. The system according to claim 2, further comprising:
a tuner for tuning either an amplitude or phase of a signal input to said oscillation excitation means;
a computing element for mixing a signal modulated by the oscillation of said receptor with a signal input to said oscillation excitation means to create a mixed signal; and
means for filtering low frequency component signals from said mixed signal.

4. The system according to claim 3, wherein the phase of said signal input to said oscillation excitation means is tuned such that each of said low frequency component signals comes to have a maximum intensity, and said tuned signal is mixed with a signal modulated by the oscillation of said receptor and output from a light detector.

5. The system according to claim 3, further comprising:
two optical waveguides diverged on said substrate, wherein said receptor is immobilized at one of said two optical waveguides with use of said tether molecule, and a light transmitted through one of said two optical waveguides interferes with a light transmitted through the other optical waveguide.

6. The system according to claim 3, further comprising:
means for optimizing both phase and duty cycle of said signal input to said oscillation excitation means; and
means for outputting data representing said optimized phase and duty cycle to an external destination.

7. The system according to claim 3, wherein said optical waveguide includes a first and second end and said optical waveguide diverges into first and second optical waveguides at said first end and converge together at said second end,
further wherein said two diverged optical waveguides are provided such that a light transmitted through said first optical waveguide has a wavelength that is different from that of a light transmitted through said second optical waveguide,
and further wherein said light injecting means includes a tunable laser beam that can change the wavelengths of its emitted light that is injected into each of said optical waveguides.

8. The system according to claim 2, wherein said light detecting means is comprised of:
means for combining and diverging light transmitted through said optical waveguide and a light transmitted other than through said optical waveguide; and
an optical detector for detecting said combined/diverged light.

9. The system according to claim 2, wherein a frequency generated by said oscillation excitation means for exciting the oscillation of said receptor differs from that of said receptor measured by said signal processing part.

10. The system according to claim 9, wherein a frequency generated by said oscillation excitation means for exciting the oscillation of said receptor is double or half of that of said receptor measured by said signal processing part.

11. The system according to claim 3, wherein said microparticle has a high optical absorbance or specific wavelength.

12. A detection system for biological substances, comprising:
a substrate including a dielectric substrate capable of transmitting a light and a thin film formed on said dielectric substrate;
means for injecting light into an interface between said dielectric substrate and said thin film at a predetermined angle with respect to a rear side of said thin film;
means for measuring an attribute (intensity, spectrum, and/or intensity distribution) of light reflected from said interface, wherein said system detects an object substance contained in a fluid in contact with said thin film;
a receptor to be selectively coupled with said object substance;
oscillation excitation means for exciting the oscillation of said receptor; and
means for measuring any of the amplitude, frequency, and/or phase of the oscillation of said receptor.

13. The system of claim 12, further comprising:
microparticles including tether molecules for tethering said receptor to a surface of said thin film and enabling said receptor to oscillate, said microparticles sensitive to an electric field generated by said oscillation exiting means.

14. The system according to claim 13, wherein said thin film consists of a metallic thin film and excites surface plasmon by enabling a light to be injected into the rear side of said metallic thin film at a predetermined angle with respect to said rear side of said metallic thin film, and further wherein the intensity, spectrum, or intensity distribution of said light reflected from said interface is modulated.

15. The system according to claim 13,
wherein said thin film consists of a single or a plurality of dielectric thin films having a refractive index different from that of said dielectric substrate; and
wherein said system injects a light into said dielectric substrate so that said light is reflected at least twice from said interface between said dielectric substrate and said dielectric thin film, between said plurality of dielectric thin films, or between said dielectric thin film and said fluid that contains said object substance; and
wherein said system measures the intensity, spectrum, or intensity distribution of said light reflected at least twice from said interface between said dielectric thin films.

16. A detection system for biological substances, comprising:
an optical waveguide provided on a substrate;
a metallic thin film formed at a side surface of said optical waveguide;
means for exciting surface plasmon by injecting a light into said optical waveguide;
means for measuring an attribute (intensity, spectrum, or intensity distribution) of a light transmitted through or reflected from said waveguide;
means for detecting an object substance contained in a fluid being in contact with said metallic thin film;
a receptor to be coupled selectively with said object substance;
oscillation excitation means for exciting an oscillation of said receptor; and
means for measuring any of the amplitude, frequency, and/or phase of the oscillation of said receptor according to a signal output from said means for measuring said attribute of said light.

17. The system of claim 16, further comprising:
a tether molecule for tethering said receptor to a surface of said metallic thin film and enabling said receptor to oscillate.

18. The system according to claim 2,
wherein said optical waveguide has an uneven surface formed within 1 nm to 1 μm in a region where molecules to be selectively coupled with an object substance are immobilized.

20. The system according to claim 2,
wherein said receptor is any of an antigen, cytokline, antibody, DNA, or RNA.
